(19) United States
(12) Patent Application Publication
(10) Pub. No.: US 2020/0154944 A1
(43) Pub. Date: May 21, 2020

(54) COMMUNICATION SYSTEM FOR COOKING DEVICE

(71) Applicant: GMG Products LLC, Lakeside, OR (US)

(72) Inventor: David W. Baker, Lakeside, OR (US)

(21) Appl. No.: 16/697,868

(22) Filed: Nov. 27, 2019

Related U.S. Application Data
(63) Continuation-in-part of application No. 16/193,622, filed on Nov. 16, 2018.

(51) Int. Cl. A47J 36/32; A47J 37/07; A23L 5/10; H04N 7/18; H04N 5/225; H04N 5/232; H04L 12/24; H04L 29/06

(52) U.S. Cl. CPC A47J 36/321; A47J 37/0786; A23L 5/15; H04N 7/183; A23V 2002/00; H04N 5/23296; H04N 5/23206; H04L 41/0273; H04L 67/42; H04N 5/2253

(57) ABSTRACT

A camera mechanism may be mounted adjacent to an aperture in a grill. The aperture may be covered with a movable aperture cover. The camera mechanism may have a camera with a camera lens that may be inserted through the aperture so as to physically contact the movable aperture cover and move the movable aperture cover out of the way so that the camera lens has an unobstructed view of the food items cooking in the cooking chamber. After taking pictures and/or videos of the food items, the camera mechanism may transmit the pictures and/or videos to a client device so the user may see the food items cooking in the grill in real-time. After taking the pictures and/or videos, the camera lens may be removed from the cooking chamber through the aperture allowing the movable aperture cover to again cover the aperture in the grill. In other embodiments, the aperture may always be open, i.e., no aperture cover, or the aperture may be covered by a transparent aperture cover to facilitate taking pictures and videos of food items within the grill through the aperture.

### CROSS-REFERENCE TO RELATED APPLICATIONS

This application is a continuation-in-part of U.S. application Ser. No. 16/193,622, filed on Nov. 16, 2018, which is hereby incorporated by reference in its entirety for all purposes.

### FIELD OF THE INVENTION

The present invention generally relates to using an imaging system to remotely view a food item cooking in a cooking device, preferably in real-time.

### SUMMARY OF THE INVENTION

The present invention provides systems and methods for receiving pictures/videos in real time from a camera mechanism mounted on a cooking device as food items are cooking within the cooking device. The cooking device may be any type of desired cooking device. As non-limiting examples, the cooking device may an air fryer, grill, oven, brazier, steamer, roaster, fryer, broiler, stove or toaster oven. While the cooking device may be any type of cooking device, the present invention will be described with continuing reference to a grill. Those of ordinary skill in the art will be able to apply the present invention to other types of cooking devices using the description of the present invention in the specific non-limiting example of a grill.

The grill may have a cooking chamber configured to receive and cook food items. The grill may also have a heat source configured to adjust the temperature within the cooking chamber. The grill may also have an aperture through the cooking chamber of the grill. The aperture may be left open, covered by a transparent aperture cover or covered by a movable aperture cover.

In the embodiment using the movable aperture cover, the movable aperture cover may be pivotally mounted to the inside of the cooking chamber. The movable aperture cover may be in a closed position which thermally seals the cooking chamber or in an open position that allows a camera lens to be inserted into the cooking chamber to have an unobstructed view of the food items being cooked.

A camera mechanism may be mounted on the grill. The camera mechanism may have a camera bracket for retaining a camera with a camera lens, an electrical motor for moving the camera lens in and out of the cooking chamber of the grill and a control unit. The control unit may comprise a transceiver for receiving and sending electronic communications and control logic for implementing the functions of the camera mechanism. When a picture or video is requested the camera mechanism may insert the camera lens into the cooking chamber, take the requested pictures/videos, transmit the pictures/videos to the client device of the user and remove the camera lens from within the cooking chamber.

The above features and advantages of the present invention will be better understood from the following detailed description taken in conjunction with the accompanying drawings.

### BRIEF DESCRIPTION OF THE DRAWINGS

FIG. 1 is an illustration of a grill and a camera mechanism attached to the grill.

FIG. 2 is an illustration of a portion of a grill with a camera mechanism attached to the grill with a camera lens positioned close to an aperture in the grill. The aperture is covered by a transparent aperture cover so that the camera lens has a view of the food items cooking in the grill through the transparent aperture cover.

FIG. 3 is an illustration of a portion of a grill with a camera mechanism attached to the grill with a camera lens position close to an aperture and outside the grill with the aperture cover in a closed position.

FIG. 4 is an illustration of a portion of a grill with the camera lens pushed forward by an electric motor through the aperture and moving the aperture cover so that the camera lens is inside the grill with the aperture cover in an open position. This gives the camera lens an unobstructed view of the food items cooking in the grill.

FIG. 5 is an illustration of the inside of a portion of a grill showing how the insertion of the camera lens through the aperture by a motor may also be used to simultaneously move the aperture from a closed position to an open position.

FIG. 6 is an illustration of an example camera mechanism.

FIG. 7 is an illustration of an example camera mechanism.

FIG. 8 is an illustration of a camera bracket that may be used to hold a camera and/or camera lens.

FIG. 9 is an illustration of a spur gear having spur gear teeth which may be part of a camera bracket and rotated by a motor to move a camera lens between a position outside of the grill and a position inside of the grill.

FIG. 10 is an illustration of a rack having rack teeth which may be part of a camera bracket and moved linearly by the spur gear and motor so as to move the camera lens between a position outside of the grill and a position inside of the grill.

FIG. 11 is an illustration of a client device communicating directly with a camera mechanism, such as by using the Bluetooth protocol.

FIG. 12 is an illustration of a client device communicating via a local area network with a camera mechanism.

FIG. 13 is an illustration of a client device communicating via the Internet with a camera mechanism.

FIG. 14 is a flowchart of a method of a cook viewing food items on a client device being cooked in a grill in real-time with a movable camera lens and a movable aperture cover.

FIG. 15 is a flowchart of a method of a cook viewing food items on a client device where a camera lens is able to view the food items in the grill through a transparent aperture cover.

FIG. 16 is a diagram showing the transfer of information between a client device and a camera mechanism.

FIG. 17 is a diagram showing the transfer of information between a client device, Local Area Network (LAN) and camera mechanism.

FIG. 18 is a diagram showing the transfer of information between a client device, Internet and camera mechanism.

FIG. 19 is a diagram showing the transfer of information between a client device, Internet, LAN or Wi-Fi and camera mechanism.

FIG. 20 is a flowchart of a method of a cook viewing food items being cooked in a cooking chamber on a client device that also protects a camera mechanism from damage.

FIG. 21 is an example of a splash screen which may be part of an application loaded on the client device and displayed on the client device for use by the user.

FIGS. 22-30 are example screens which may be part of the application loaded on the client device and displayed and used to assist the user in connecting the imaging device (camera) and the client device (cell phone or computer) of the user to a WiFi network.

FIGS. 31-33 are example screens which may be part of the application loaded on the client device which may be used to assist the user after the WiFi connections for the imaging device and the client device have been established.

FIGS. 34-38 are example screens which may be part of the application loaded on the client device and used to take and view one or more photographs and/or videos of the inside the grill.

FIGS. 39-42 are example screens which may be part of the application loaded on the client device and used to periodically take one or more photographs and/or videos of the inside of the grill.

FIG. 43 is an example of an about application screen which may be part of the application loaded on the client device and used to inform the user about the use of the present invention.

FIG. 44 is an example support page which may be part of the application loaded on the client device and used to inform the user about support matters, such as online resources that may be referenced on the Internet.

FIGS. 45-49 are example screens which may be part of the application loaded on the client device and used by the user to connect to a server.

FIG. 50 is a block diagram of the cooking device operably coupled with a remote server, according to some examples.

FIG. 51 is a diagram illustrating that in some embodiments, the client device may be wirelessly connected directly to the camera mechanism. This may be particularly advantageous during a first time connect so that the client device (mobile app) and/or camera mechanism may be initialized and configured to recognize and find each other.

FIG. 52 is a diagram illustrating that in some embodiments, the client device may be wirelessly connected to the camera mechanism, via a wireless router (such as a WiFi router).

FIG. 53 is a diagram illustrating that in some embodiments, the client device may be wirelessly connected to a server (possibly via a wireless router not shown) and the server may be wireless connected to the camera mechanism, possible via another wireless router (such as a WiFi router).

FIG. 54 illustrates a first embodiment where a client device (labeled Mobile App) transmits a server command to a server, the server encodes the server command into a camera command and the server transmits the camera command to the camera mechanism.

FIG. 55 illustrates a second embodiment where a client device (labeled Mobile App) transmits a server command to a server and the server transmits the unchanged server command as a camera command to the camera mechanism.

FIGS. 56, 57 illustrate a method where a server, having received a request for a plurality of pictures/videos, separated by a selected time interval, from a client device, periodically requests, at the selected time interval, a picture/video from the camera mechanism and upon receipt, transmits the picture/video to the client device.

FIGS. 58, 59 illustrate a method where a camera mechanism, having received a request for a plurality of pictures/videos, separated by a selected time interval, from a server, periodically takes a picture/video and forwards the picture/video to the server, which transmits the picture/video to the client device.

FIG. 60 illustrates an electronic look-up table that may be used by a server to encode a server command, received from a client device, into a camera command, that is to be transmitted to the camera mechanism.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

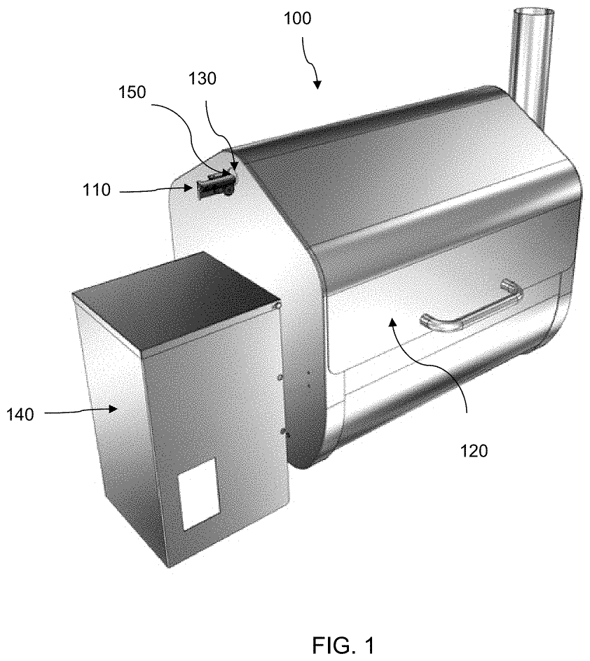

With reference to FIG. 1, a perspective view of an example cooking device 100 with an attached or mounted camera mechanism 110 is illustrated. The cooking device may be any type of desired cooking device. As non-limiting examples, the cooking device may an air fryer, grill, oven, brazier, steamer, roaster, fryer, broiler, stove or toaster oven. While the cooking device may be any type of cooking device, the present invention will be described with continuing reference to a grill 100. Those of ordinary skill in the art will be able to apply the present invention to other types of cooking devices 100 using the description of the present invention in the non-limiting example of a grill 100. Any person or group of people that uses the cooking device or the grill 100 to cook a food item is referred herein as a user or a cook.

The grill 100 may use any desired fuel for heating the grill 100. As non-limiting examples, the heat source 140 for the grill 100 may be a pellet, wood, charcoal, stick burner, natural gas or gas. The heat source 140 is preferably sufficient to sustain a temperature inside the grill 100 of around 350 to 500 degrees Fahrenheit for cooking the food items. In some embodiments, the grill 100 may be able to automatically (without human intervention) regulate the temperature inside the cooking grill 100 to a predetermined set temperature. The heat source 140 may also be sufficient to heat the cooking chamber 120 inside the grill 100 to even higher temperatures to thermally clean the inside of the grill 100.

The grill 100 may also be made of any desired heat resistant material(s). As non-limiting examples, the grill 100 may be made of stainless steel (austenitic or ferritic), sheet steel and/or cast iron. The grill 100 is shaped to have an enclosed inner chamber, i.e., a cooking chamber 120, which may be heated by the heat source 140. The cooking chamber 120 may receive the food items through a lid which may be raised (opening the cooking chamber 120) and lowered (closing the cooking chamber 120) and cook any desired food items, such as meats or vegetables.

The grill 100 may also have an opening, i.e., an aperture 130, through the cooking chamber 120. While the aperture 130 may be any desired size, in preferred embodiments the aperture 130 is made as small as possible. Also, the aperture 130 may be any desired shape, such as, as non-limiting examples, a circle or a rectangle. In general, the aperture 130 is preferably less than three inches in diameter or three inches to a side.

The present invention encompasses three different embodiments for the aperture 130. In the first embodiment, the aperture 130 is continually left uncovered so that the aperture 130 may act as a viewing port, thereby allowing a camera lens 150 of a camera 210 to have an unobstructed view of the food items cooking in the cooking chamber 120. This embodiment has the advantage that it requires the fewest parts and is the simplest to build and use. However, this embodiment may allow heat to escape from the cooking chamber 120 through the aperture 130, thereby requiring more fuel to be burned by the heat source 140. This embodiment also allows heat passing through the aperture 130 to come in close contact with the camera lens 150 when camera lens 150 is positioned outside cooking chamber 120, which may damage or shorten the life of the camera lens 150 or allow the camera lens 150 to become dirty.

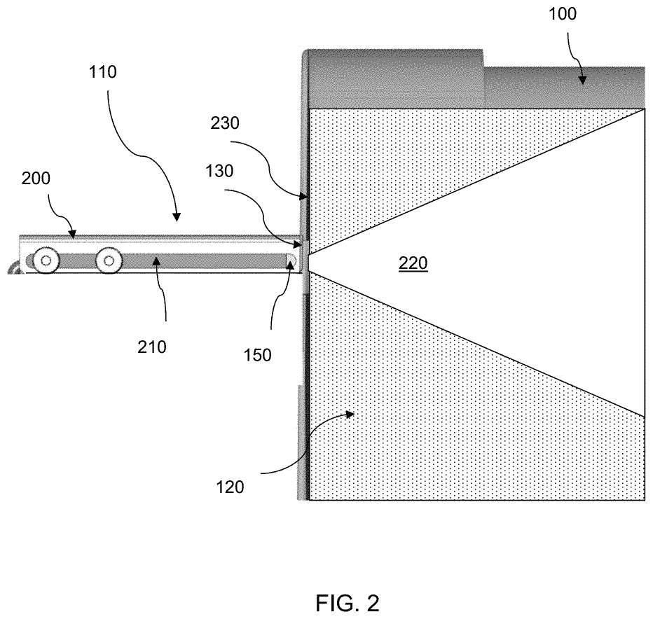

A second embodiment is illustrated in FIG. 2. This illustration is a side view of a non-moving camera mechanism 110 mounted to the outside of the grill 100. Only a portion of the grill 100 and the cooking chamber 120 are shown in this illustration. In this embodiment, the aperture 130 is covered by a transparent aperture cover 230. The transparent aperture cover 230 may be made of glass or any other transparent heat resistant material. This embodiment is relatively simple to build and use and has the advantages of keeping the cooking chamber 120 thermally closed and protecting the camera lens 150. However, this embodiment has the disadvantage of placing an obstacle (the transparent aperture cover 230) between the camera lens 150 and the food items. Further, the transparent aperture cover 230 is likely to get dirty from either smoke or food particles coming off of the food items while being cooked. A dirty transparent aperture cover 230 may reduce the quality of any pictures/videos taken of the food items cooking in the cooking chamber 120.

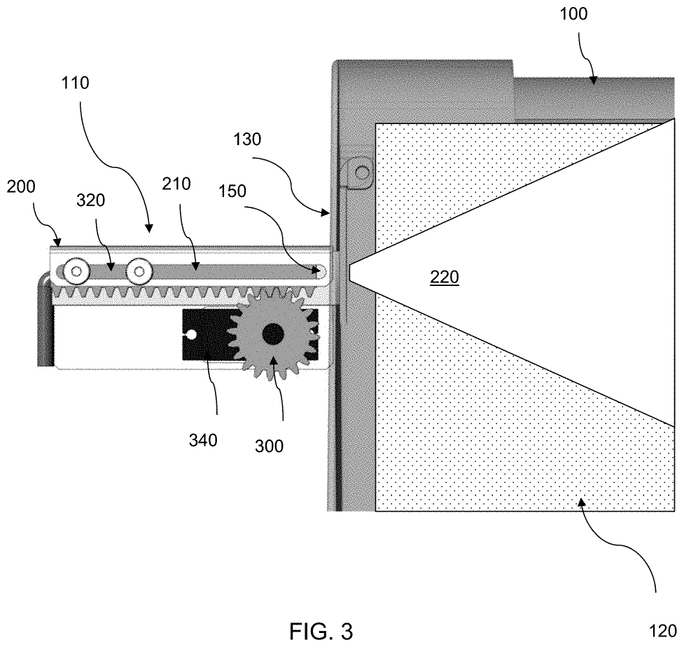

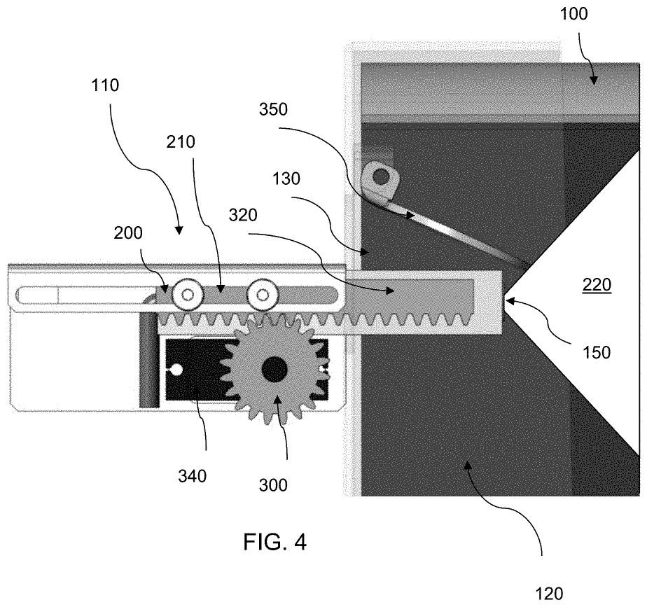

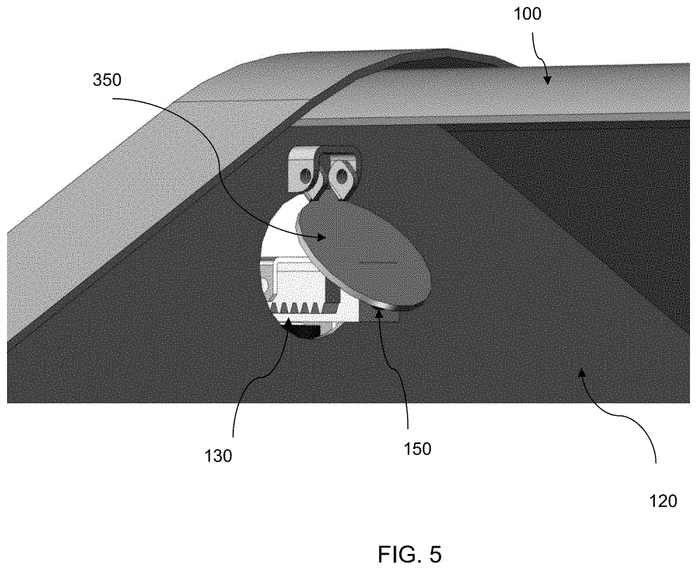

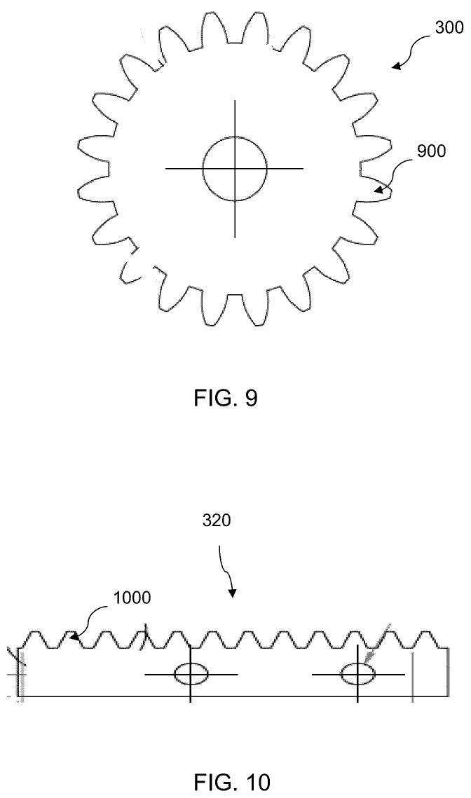

A third embodiment is illustrated in FIGS. 3-7, 9 and 10. FIG. 3 is a side view of a movable camera mechanism 110 mounted to the outside of grill 100, with the camera lens 150 being in a retracted/withdrawn position outside of the grill 100. Only a portion of the grill 100 and the cooking chamber 120 are shown in FIG. 3. FIG. 4 is a side view of a movable camera mechanism 110 mounted to the outside of the grill 100, with the camera lens 150 being in an extended/forward position inside of the grill 100. Only a portion of the grill 100 and the cooking chamber 120 are shown in FIG. 4. FIG. 5 is a perspective view of a movable camera mechanism 110 mounted on the outside of the grill 100, with the camera lens 150 in an intermediate position. The intermediate position of the camera lens 150 may occur during either the insertion of the camera lens 150 into the grill 100 or the withdrawal of the camera lens 150 from the grill 100. Only a portion of the grill 100 and the cooking chamber 120 are shown in FIG. 5.

In this embodiment, the aperture 130 is covered by a movable aperture cover 350. The movable aperture cover 350 does not need to be transparent and may be made of any thermally resistant material, such as, as non-limiting examples, stainless steel, sheet steel or cast iron. In this embodiment, the movable aperture cover 350 may be moved out of the way so that the camera lens 150 has an unobstructed view of the food items in the cooking chamber 120 through the aperture 130.

In a preferred embodiment, the camera lens 150 may be inserted into the cooking chamber 120 during the taking of pictures/videos of the food items while the food items are cooking in real-time. After the pictures/video of the food items are taken, the camera lens 150 may be withdrawn from the cooking chamber 120 and the movable aperture cover 350 may be positioned to cover the aperture 130. Any desired method of biasing the movable aperture cover 350 against the aperture 130 may be used. As non-limiting examples, the movable aperture cover 350 may be held against the aperture 130 by gravity or by springs. In a preferred embodiment, the movable aperture cover 350 is pivotally connected to the cooking chamber 120 and arranged so that gravity pulls the movable aperture cover 350 down and against the aperture 120.

Thus, the movable aperture cover 350 is preferably able to be moved between a closed position, which protects the thermal integrity of the cooking chamber 120 and thermally isolates the camera mechanism 110 from the cooking chamber 120, and an open position, which allows the camera 210 to take unobstructed pictures/videos of the food items in real-time, either from being positioned adjacent, but outside the cooking chamber 120 or by being inserted into the cooking chamber 120, while the food items are cooking.

In a preferred embodiment as illustrated in FIGS. 4 and 5, the movable aperture cover 350 is pivotally mounted on the inside of the grill 100 in the cooking chamber 120 so that as the camera lens 150 is inserted into the cooking chamber 120, the camera lens 150 physically contacts and moves the aperture cover from the closed position covering the aperture 130 to the open position not covering the aperture 130. In addition, after the pictures/videos have been taken, the aperture cover may move from the open position to the closed position as the camera lens 150 is withdrawn from the cooking chamber 120.

Referring to FIG. 2, an example camera mechanism 110 is illustrated that may be mounted on the grill 100. In this embodiment, the camera 210 and camera lens 150 are stationary and are able to take pictures/videos through an open aperture 130 or a transparent aperture cover 230 as previously described. An example field of view 220 of the camera lens 150 is illustrated in FIGS. 2-4.

Referring to FIGS. 3-7, an example camera mechanism 110 is illustrated that may be mounted on the grill 100. In this embodiment, the camera lens 150 may be inserted through an aperture 130 in the grill 100, thereby moving an aperture cover from a closed position to an open position and providing the camera lens 150 an unobstructed view of the food items cooking in the cooking chamber 120. The aperture cover is in a closed position in FIG. 3 while the aperture cover is in an open position in FIGS. 4 and 5.

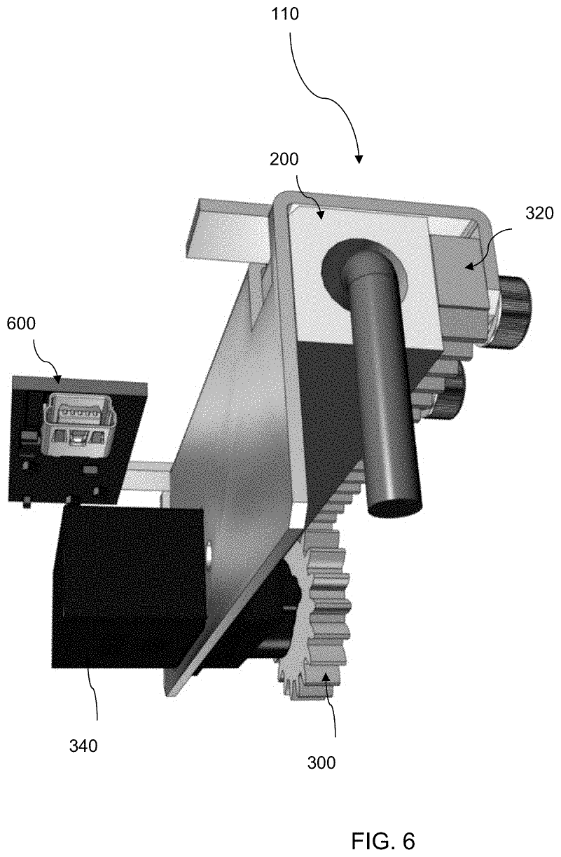

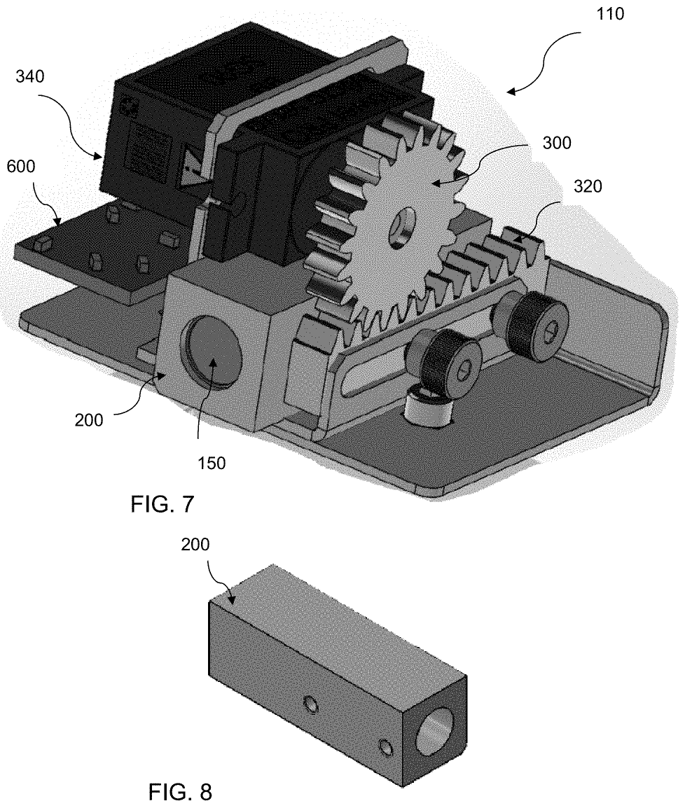

While any desired camera mechanism 110 may be used, in preferred embodiments, the camera 210 and/or the camera lens 150 are mounted to a camera bracket 200. The camera bracket 200, as illustrated in FIGS. 3, 4, 6 and 7, may be mounted to a rack 320. FIG. 6 is a perspective view of an example camera mechanism. FIG. 7 is a perspective view from the bottom of the example camera mechanism. A non-limiting example of a rack 320 is illustrated in FIG. 10. The teeth 1000 of the rack 320 may be positioned adjacent the teeth 900 of a spur gear 300, as illustrated in FIGS. 3, 4, 6 and 7. The spur gear 300 may also be part of the camera mechanism 110 and be attached, possibly via other gears, to an electrical motor 340. The electrical motor 340 may be controlled to be turned on or off by a control unit 600. An example control unit 600 is illustrated in FIGS. 6 and 7. The control unit 600 may have a wireless transceiver and computer logic. The control unit 600 may be configured to receive commands from a client device 1100, transmit commands to the electronic motor 340, transmit data to the client device 1100, receive a still picture or a video from the camera 210 and transmit the picture/video to the client device 1100. The client device 1100 may be, as non-limiting examples, a cell phone, tablet, laptop or desktop computer. The client device 1100 may be in communication with the camera mechanism 110 by any desired means.

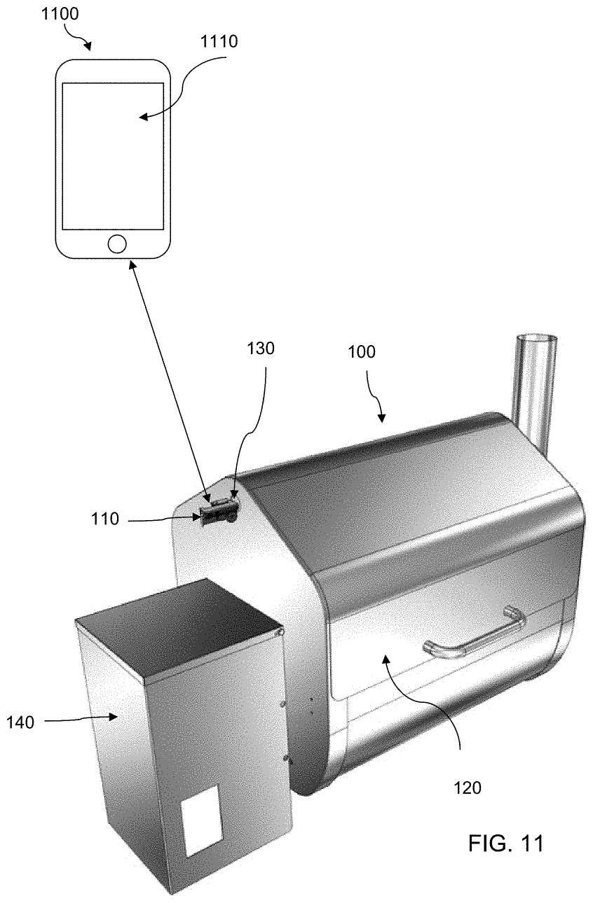

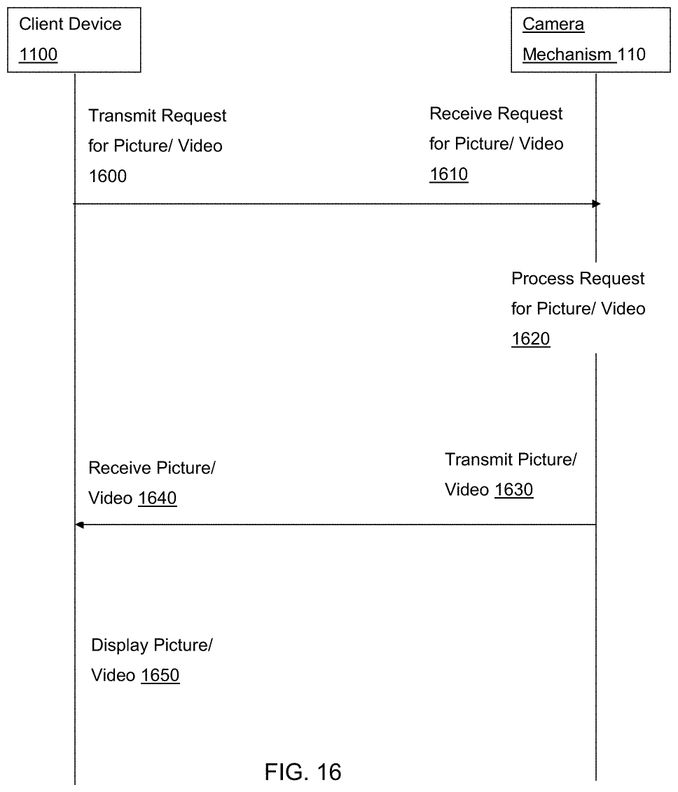

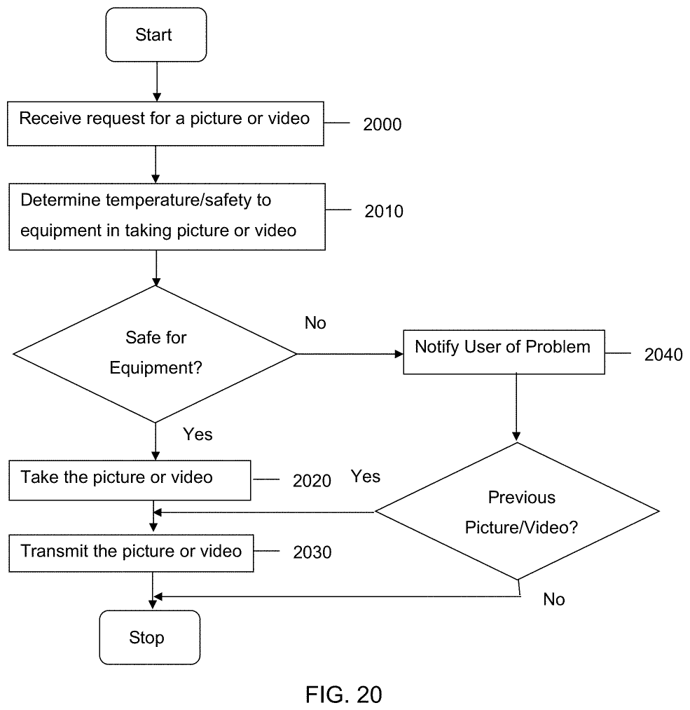

Another embodiment of the invention is illustrated in the flowchart of FIG. 20. With reference to FIGS. 11 and 16, the client device 1100 may be in communication with the camera mechanism 110 directly, such as by using a short range protocol such as Bluetooth. In this example embodiment, the client device 1100 may transmit a request for a picture or video directly to the camera mechanism 110. (Steps 1600) The camera mechanism 110 may receive the request from the client device 1100 (Step 1610) and process the request using a control unit 600 comprising computer logic (Step 1620). The computer logic, which may include computer software or firmware, may determine what course of action to take.

The camera mechanism 110 may determine it is safe for the camera lens 150 to be inserted into the cooking chamber 120, e.g., the camera lens 150 is not too hot, possibly as enough time has passed to cool the camera lens 150 or a thermometer has measured that the temperature of the camera lens 150 is within a safe range, and insert the camera lens into the cooking chamber 120. The safe operating temperature for the camera mechanism 110 and the camera lens 150 may be determined empirically.

The camera mechanism 110 may determine that the camera lens 150 is too hot or that it is unsafe to insert the camera lens 150 into the cooking chamber 120. In this event the camera mechanism 110 may send a notification back to the client device 1100 that it is unsafe to take a picture or video at this time and/or send the most recent picture or video taken with a notification to the client device 1100 that the transmitted picture or video is not in real-time and preferably display on the client device a time stamp or reference to how old the picture or video is.

In another embodiment, the camera mechanism 110 may periodically take pictures or video of the food items cooking in the cooking chamber 120 at a set interval. Any set interval may be used. As non-limiting examples, the camera mechanism 110 may be automatically taking pictures every 30 seconds, every minute, every 5 minutes or every 10 minutes. Thus, when a request for a new picture or video is received, the camera mechanism 110 may send the most recent picture or video of the food items cooking in the cooking chamber 120.

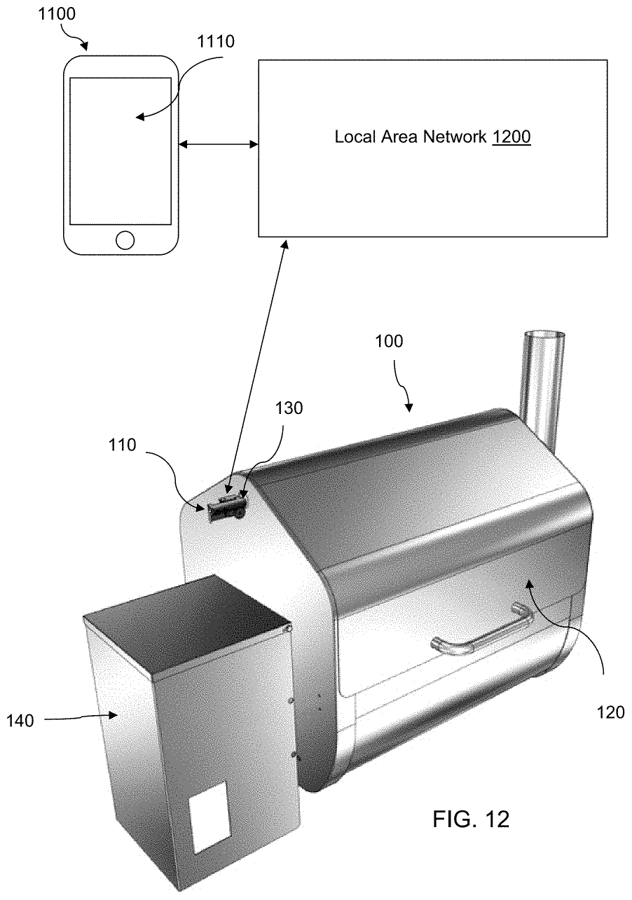

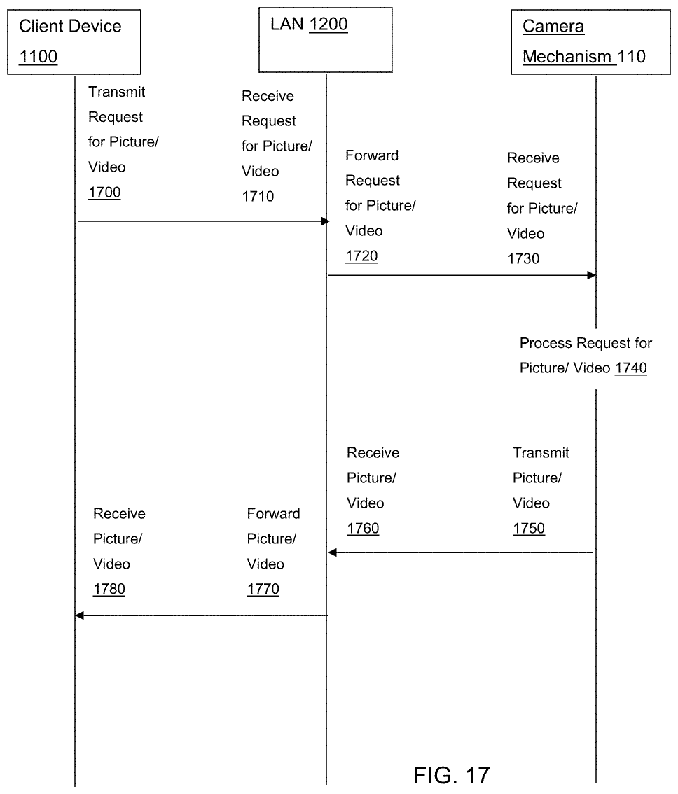

With reference to FIGS. 12 and 17, the client device 1100 may be in communication with the camera mechanism 110 through a local area network (LAN) 1200 (which could be a router or a Wi-Fi system). In this embodiment, the client device 1100 may transmit a request for a picture or video to the LAN 1700 (Steps 1700 and 1710), which forwards the request to the camera mechanism 110 (Steps 1720 and 1730). As previously described, the control unit 600 of the camera mechanism 110 may process the request and decide which action to take. (Step 1740). The camera mechanism 110 may transmit the picture or video the LAN 1700 (Steps 1750 and 1760), which forwards the picture or video to the client device 1100. The client device 1100 may display the picture or video to a user or cook on a display 1110 of the client device 1100.

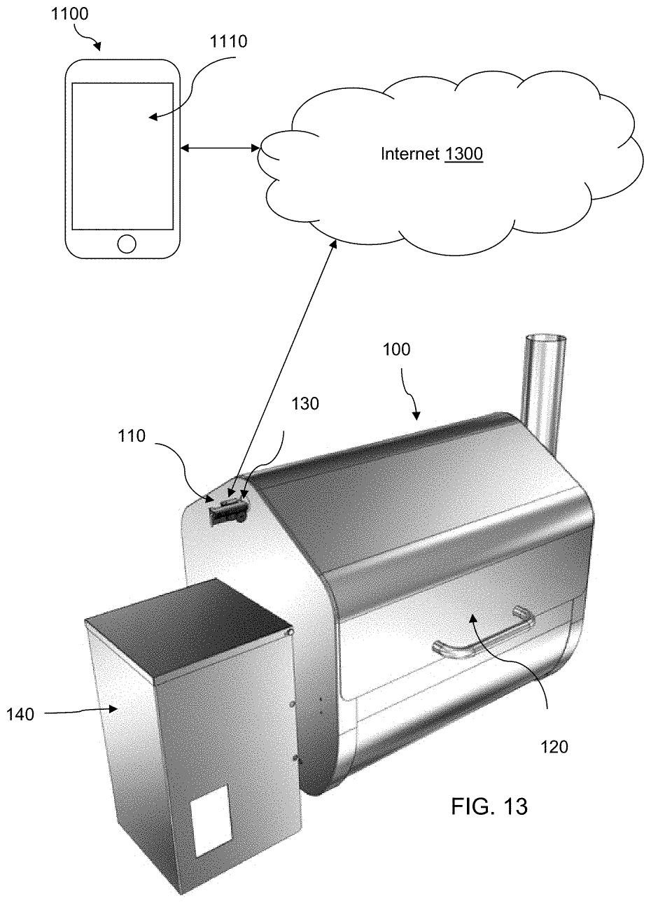

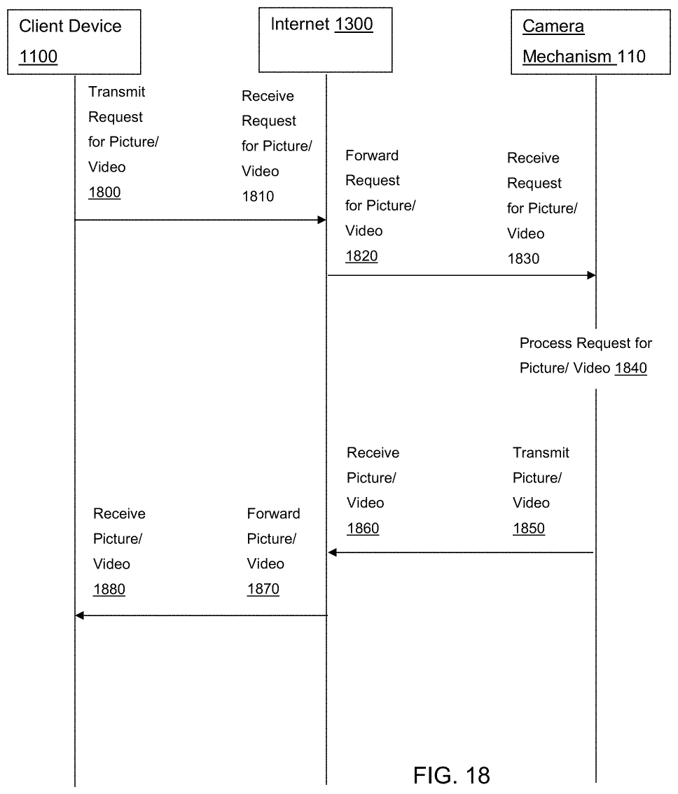

With reference to FIGS. 13 and 18, the client device 1100 may be in communication with the camera mechanism 110 through the Internet 1300. In this embodiment, the client device 1100 may transmit a request for a picture or video through the Internet 1300 (Steps 1800 and 1810), which forwards the request to the camera mechanism 110 (Steps 1820 and 1830). As previously described, the control unit 600 of the camera mechanism 110 may process the request and decide which action to take. (Step 1840). The camera mechanism 110 may transmit the picture or video through the Internet 1300 (Steps 1850 and 1860), which may forward the picture or video to the client device 1100. The client device 1100 may display the picture or video to a user or cook on a display 1110 of the client device 1100.

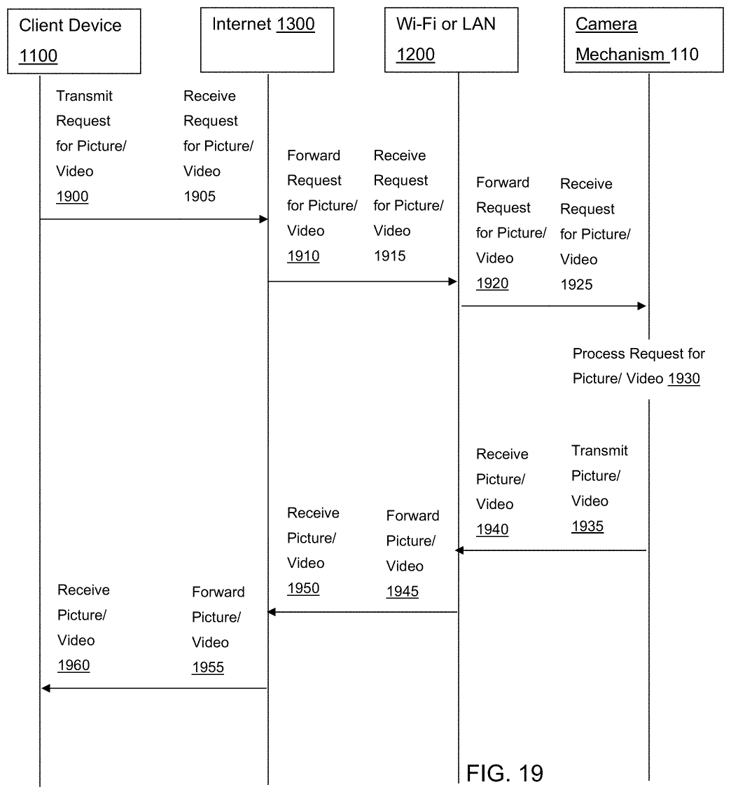

With reference to FIG. 19, the client device 1100 may be in communication with the camera mechanism 110 through the Internet 1300 and a LAN 1200. In this embodiment, the client device 1100 may transmit a request for a picture or video through the Internet 1300 (Steps 1900 and 1905), which forwards the request to a LAN 1200 (Steps 1910 and 1915), which forwards the request to the camera mechanism 110 (Steps 1920 and 1925). As previously described, the control unit 600 of the camera mechanism 110 may process the request and decide which action to take. (Step 1930) The camera mechanism 110 may transmit the picture or video through the LAN 1200 or Wi-Fi (Step 1935 and 1940), which may forward the picture or video through the Internet 1300 (Steps 1940 and 1950), which may forward the picture or video to the client device 1100. The client device 1100 may display the picture or video to a user or cook on a display 1110 of the client device 1100.

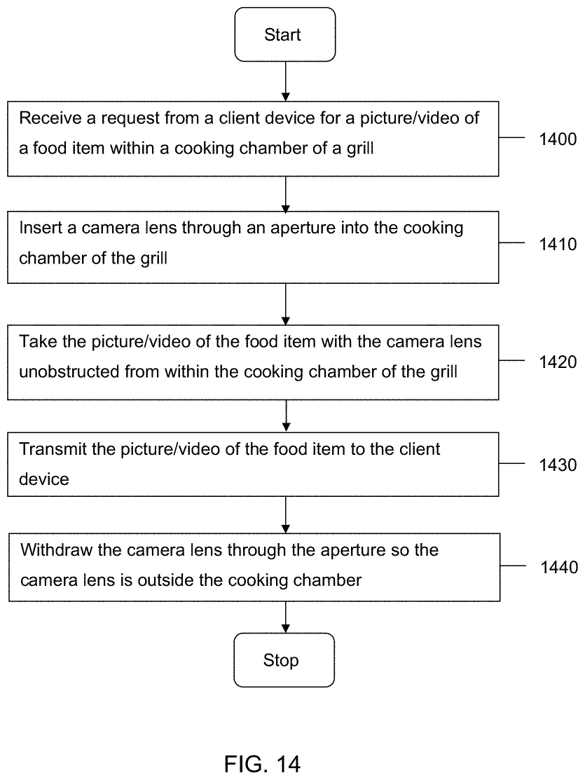

An example method of practicing the invention is shown in the flowchart in FIG. 14. A user, typically the cook, may start a grill 100 so as to heat the cooking chamber 120 to a desired temperature and place one or more food items, i.e., tasty foods, such as meats and/or vegetables into the cooking chamber 120. The user may not want to stay close to the grill 100, but still be able to view the food items in the cooking chamber 120 as the food items cook in real-time. Thus, the invention allows the user to stay in the house (possibly watching TV with friends, visiting a store, going on a bicycle ride, etc.) while still being able to visually monitor the food items as the food items cook in the cooking chamber 120. Thus, the user may remotely view the food items cooking in real-time, i.e., the user sees on the client device 1100 what the food items look like at the time the user is viewing the food items on the client device 1100. In other words, the user is not seeing what the food items looked like in the past, but what the food items currently look like. This real-time view helps the user in judging when to stop cooking the food items.

In some embodiments, a software application may be downloaded to the client device 1100 of the user. Using the application, the user may request a picture or video of the food items in the cooking chamber 120 while the food items are cooking in real-time. (Step 1400) The pictures/videos may be of any desired length or timing, although the system may prevent the camera lens 150 from being exposed for too long a period within the cooking chamber 120 or at too high a temperature, if the prolonged exposure or excessive temperature might damage the camera lens 150.

In one possible embodiment, the user, using the client device 1100 with a loaded software application, may request a current picture or a current video of the food items as the food items cook in real-time. In this embodiment, the user may select to view a real-time picture or video of the food items cooking in the cooking chamber 120 at any time selected by the user. This allows the user to focus, if desired, later in the cooking time so as to closely monitor exactly when the food items should be removed from the cooking chamber 120.

In another embodiment, the user may request that a picture or a short video of the food items be automatically sent to a display 1110 of the client device 1100 of the user in a predefined or selected time period, such as, as non-limiting examples, every 30 seconds, 1 minute, 30 minutes or hour. In this embodiment, the camera mechanism 110 may automatically (without further human intervention) take a picture or a video at the selected intervals and send the picture or video to the client device 1100 as a reminder to the user that the food items are still cooking and visually show the user what the food items look like at that point in the cooking process.

In another embodiment, a control unit 600 of the camera mechanism 110, once the control unit 600 of the camera mechanism 110 has been requested or determines a picture or video should be taken, may send a command to an electrical motor 340 to turn on and run in a forward direction. The control unit 600 may comprise a transceiver for receiving and sending electrical communications and computer logic to manage the operation of the camera mechanism 110. As illustrated in FIGS. 3, 4, 6 and 7, the electrical motor 340 may spin in a clockwise direction to produce the desired forward direction of the camera lens 150. (It should be noted, although not illustrated, that the motor 340, spur gear 300, and rack 320 may be placed in other arrangements where a counterclockwise rotation of the motor 340 may produce a forward direction of the camera lens 150.) The electrical motor 340 may be connected to a spur gear 300 so that the spur gear teeth 900 may also be rotated along with the motor 340 in either a clockwise or a counterclockwise direction.

The spur gear teeth 900 may be positioned to mesh with the teeth 1000 of a rack 320, so that the rotation of the spur gear teeth 900 may produce a linear motion of the rack 320. A camera bracket 200 may be attached to the rack 320 so that the camera bracket 200 moves with the rack 320. A camera 210 and/or a camera lens 150 may be mounted to the camera bracket 200 and thus the camera 210 and/or camera lens 150 moves along with the camera bracket 200. Thus, the electric motor 340, depending on the direction of spin produced by the electric motor 340, may control the direction of the movement of the camera 210 and/or camera lens 150.

Once a desired picture or video is needed, the motor 340 may spin in the appropriate direction to push the camera lens 150 through the aperture 130, make contact with the aperture cover attached to the inside of the cooking chamber 120 and move the aperture cover to an open position so that the camera lens 150 has an unobstructed view of one or more food items being cooked in the cooking chamber 120. (Step 1410)

Once the camera lens 150 is within the cooking chamber 120, the camera mechanism 110 may take pictures and/or videos of the food items cooking in the cooking chamber 120 in real-time. (Step 1420) The camera mechanism 110 may transmit the pictures/video of the food items cooking to the client device 1100 in real time. (Step 1430) After the picture/video have been taken, the camera mechanism 110 may send a command to the electrical motor 340 to run in a reverse direction so as to remove or withdraw the camera lens 150 from the cooking chamber 120 which may also automatically close the aperture cover over the aperture 130. (Step 1440)

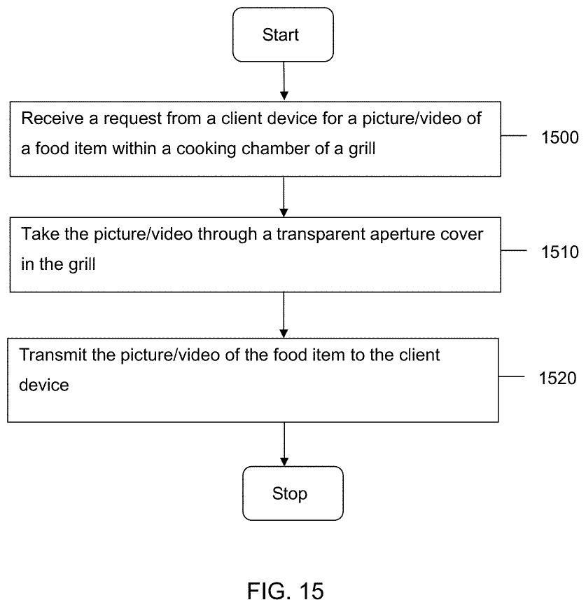

Another method of practicing the invention is illustrated in FIG. 15. In this embodiment, the aperture 130 may be considered to be open or covered with a transparent aperture cover 230. As before, the control unit 600 of the camera mechanism 110 may receive a command or determine that a picture or video is requested by the user. (Step 1500).

The camera lens 150 may be fixedly mounted to the side of the grill 100 so as to view the food items through the aperture 130 and possibly through a transparent aperture cover 230. The camera mechanism 110 may take the picture/video of the food items in the cooking chamber 120. (Step 1510) A transceiver within the camera mechanism 110 may transmit the picture or video of the food cooking in the cooking chamber 120 to the client device 1100 in real-time. (Step 1520) This allows the user to instantly see the food items in real-time as the food items cook within the cooking chamber 120 without the user having to travel to the grill 100 and without the user opening the grill 100 which may undesirably lower the temperature inside the grill 100.

In some embodiments, the grill 100 may also have a thermometer configured to measure a temperature within the cooking chamber 120 or the food item. The current temperature may be periodically transmitted to the client device 1100 or the user may request from time to time the temperature within the cooking chamber 120 or the food item as desired.

In some embodiments, the control unit 600 may be configured to automatically remove the camera lens 150 from within the cooking chamber 120 upon reaching a predefined condition. The predefined condition may be, as non-limiting examples, if the cooking chamber 120 gets too hot or the camera lens 150 is left for too long of a period with the cooking chamber 120. Either of this conditions may damage the camera lens 150 and/or the camera mechanism 110.

Another embodiment is illustrated in FIG. 20. As previously described, the camera mechanism 110 may receive a request from the client device 1100 for a picture or video. (Step 2000) The camera mechanism 110 may determine whether it is save for the various parts of the camera mechanism to take the picture or video. (Step 2010) This may be accomplished by measuring the temperature in the cooking chamber 120, measuring the temperature of some part of the camera mechanism 110 or determining that some part of the camera mechanism 110 has been in the cooking chamber 120 for too long and/or at too high of a temperature (too high of a duty cycle). If it is safe for the camera mechanism 110 to take the picture or video, the picture or video may be taken by the camera mechanism 110 (Step 2020) and transmitted to the client device (Step 2030). On the other hand, if the control unit 600 of the camera mechanism 110 determines it is not safe for some part of the camera mechanism 110 to take the picture or video, the camera mechanism 110 may transmit a message to the client device 1100 that the camera mechanism 110 is not able to take a real-time picture or video of the food items cooking in the cooking chamber 120 at this time, preferably with a detailed description of the problem and preferably what corrective action is needed and/or when a picture or video might be taken at a later time. (Step 2040) If a previous picture or video is in the memory of the control unit 600, the camera mechanism 110 may transmit this previous picture or video to the client device (Step 2030) with a notification that this is a previous picture or video.

In some embodiments, the control unit 600 may be configured to receive a turn-off command from the client device 1100 and, triggered by the turn-off command, disable the heat source 140 of the grill 100 in real-time. This allows the user to remotely turn the grill 100 off, once the food items have finished cooking.

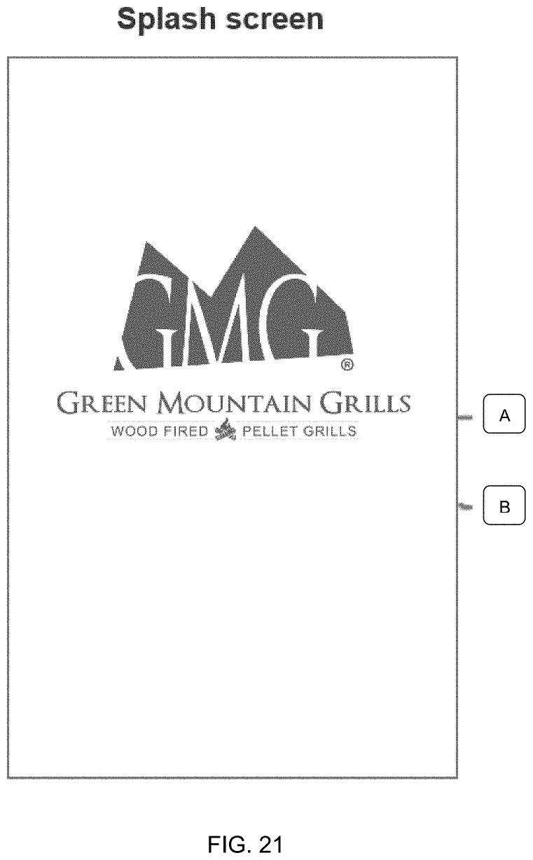

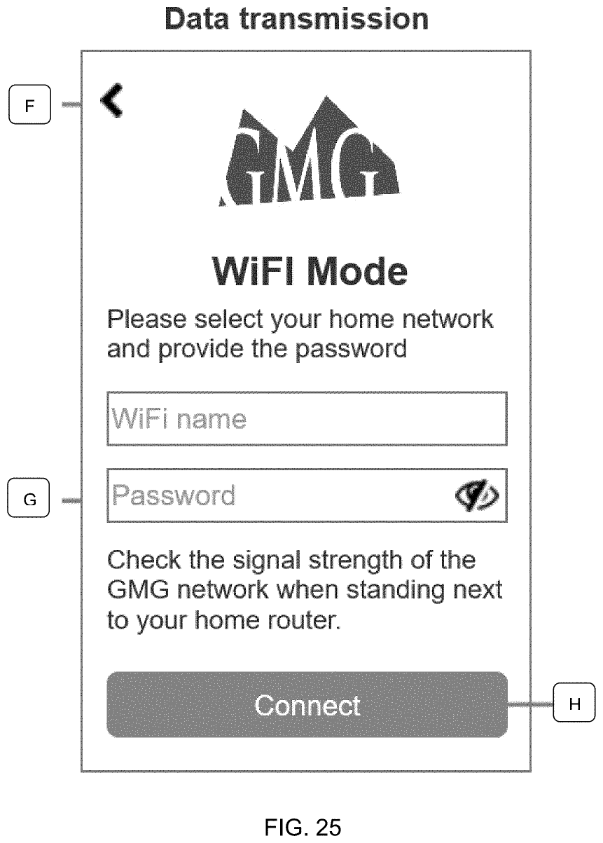

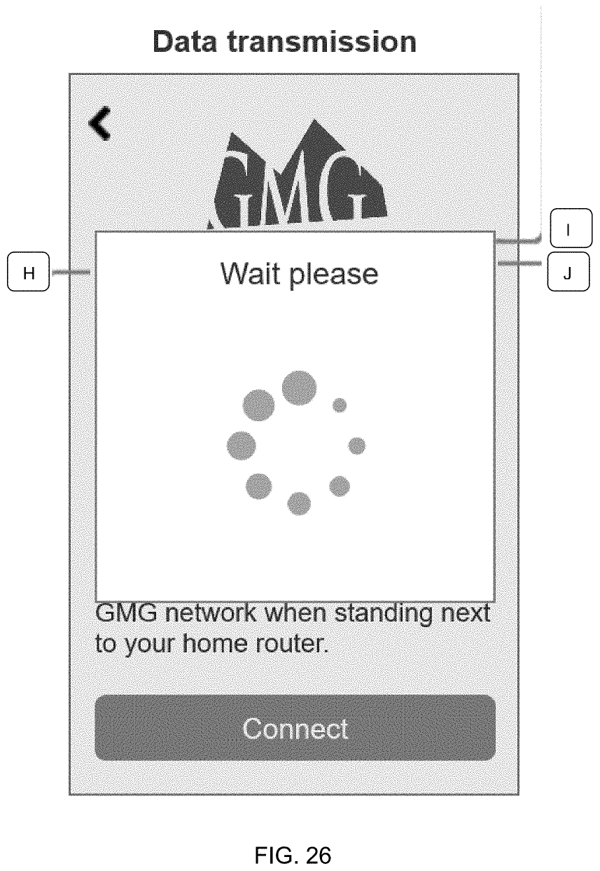

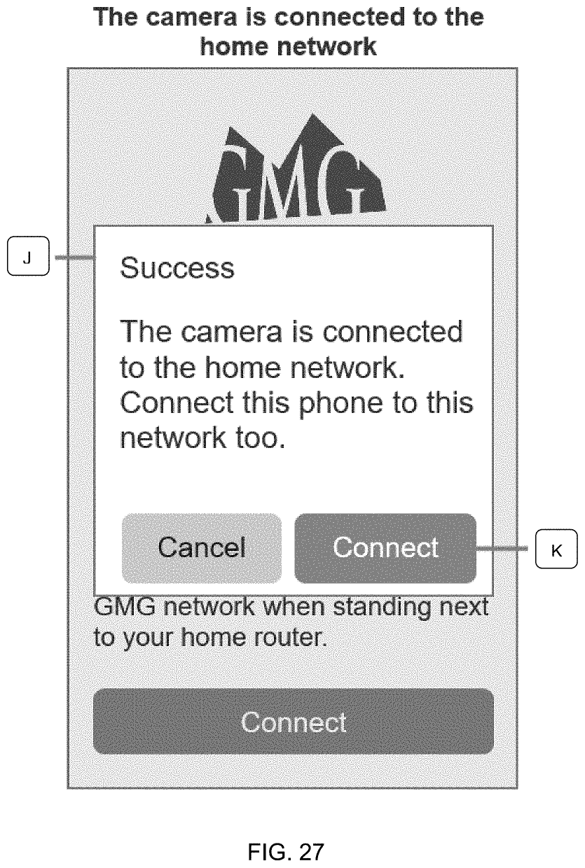

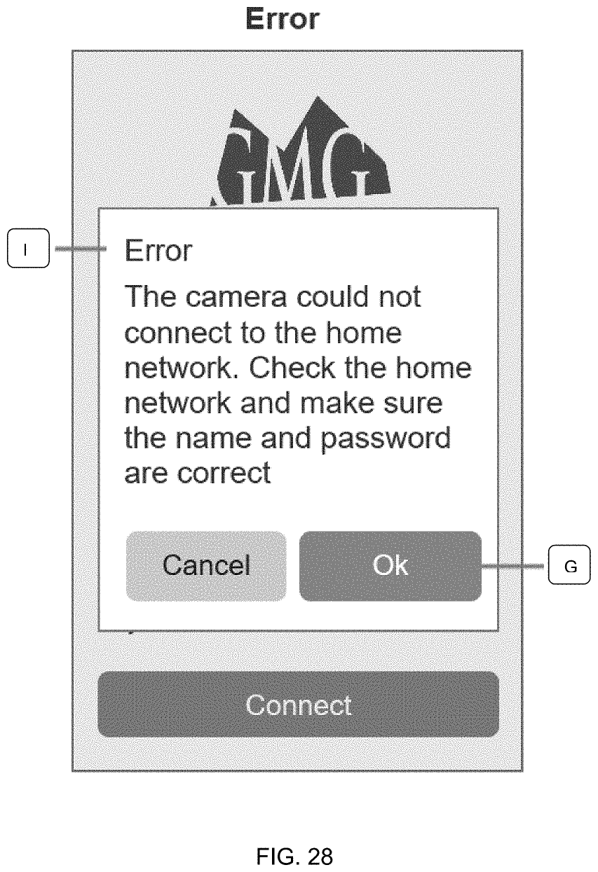

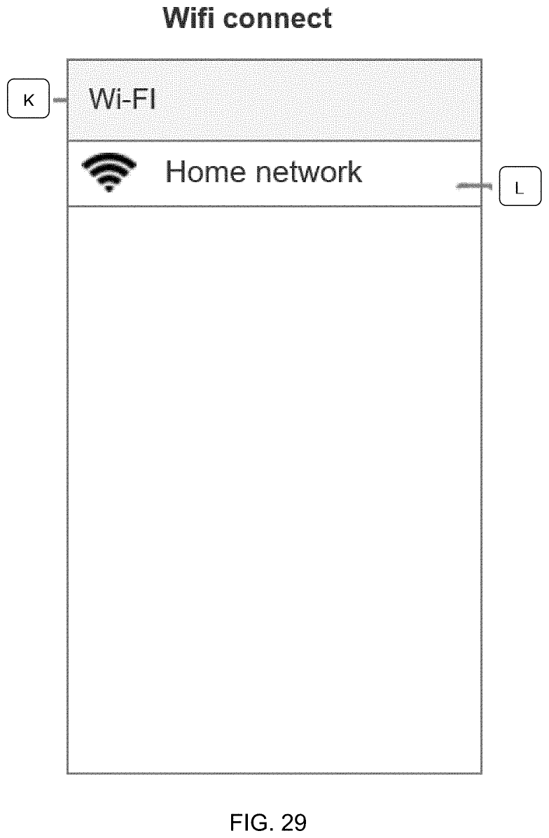

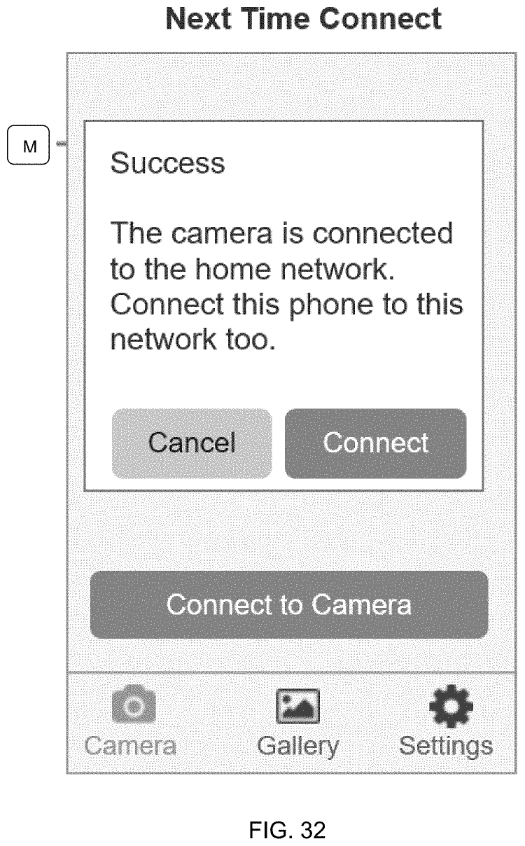

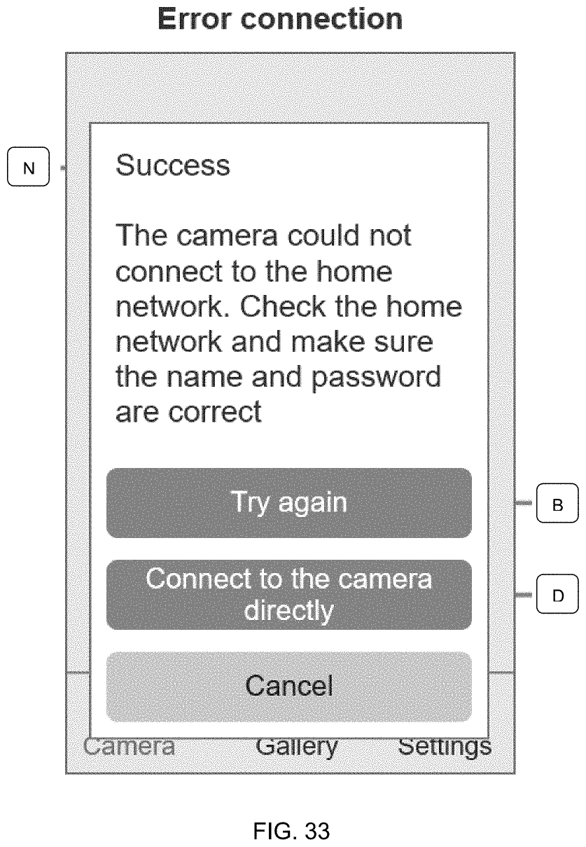

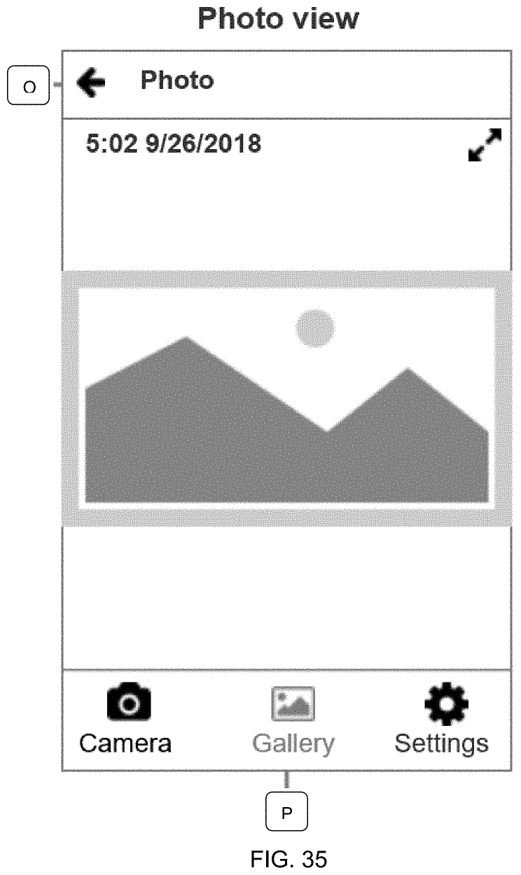

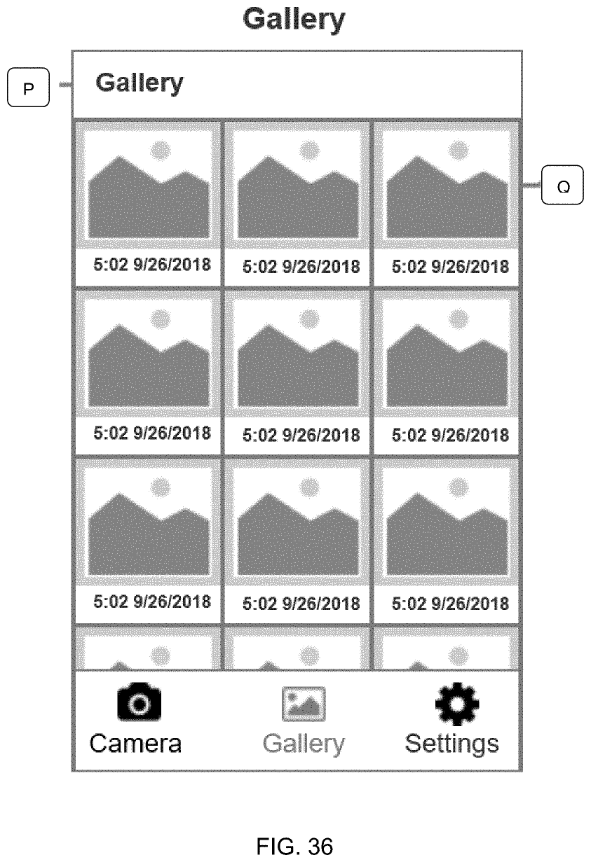

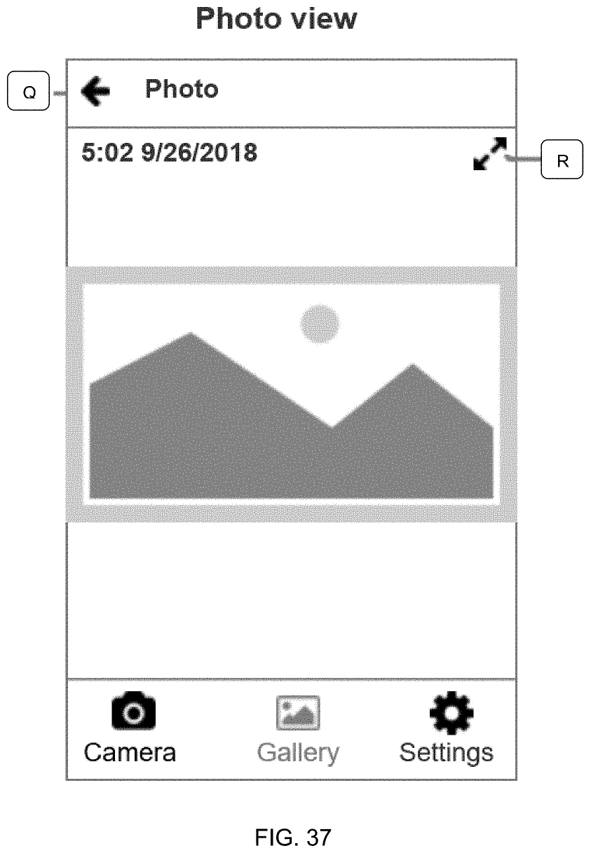

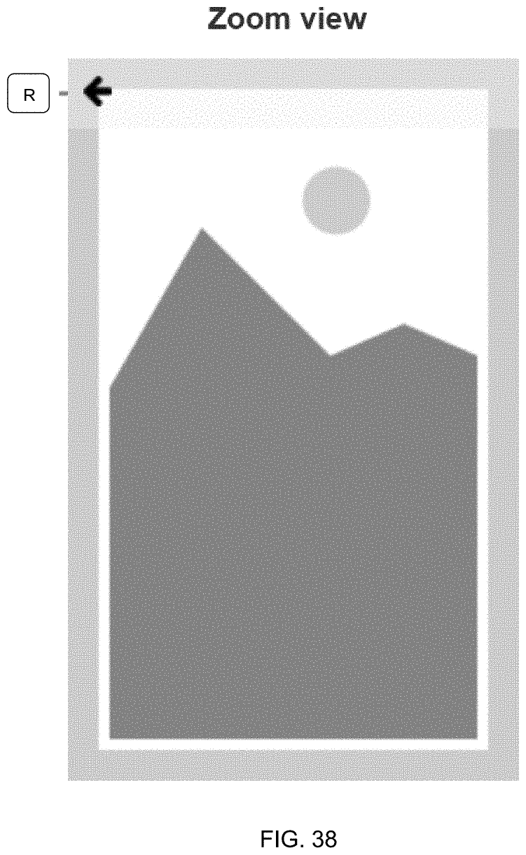

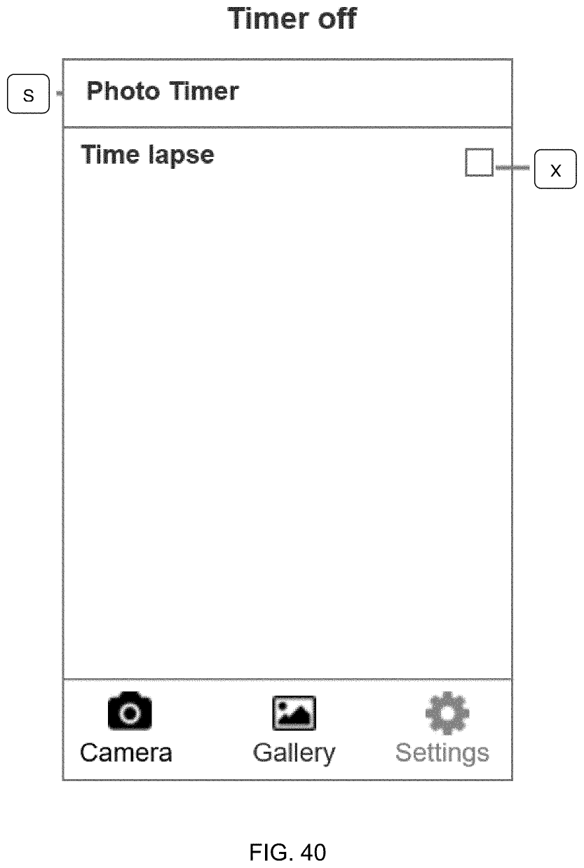

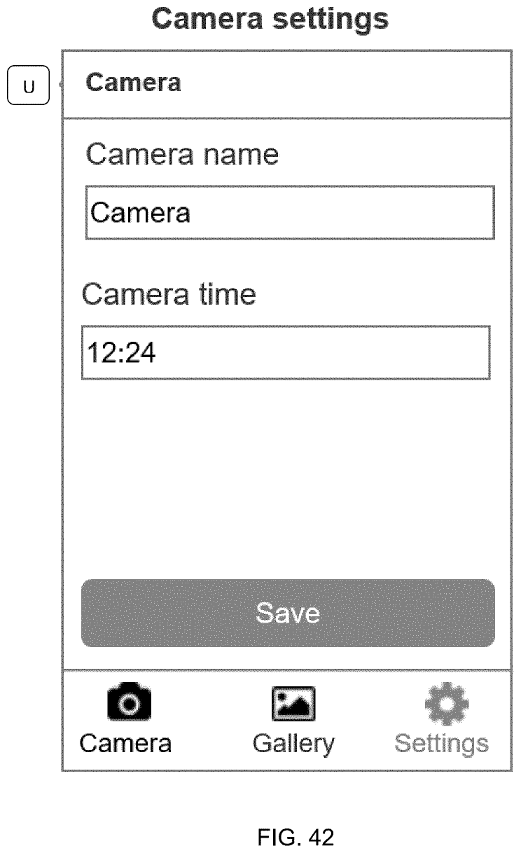

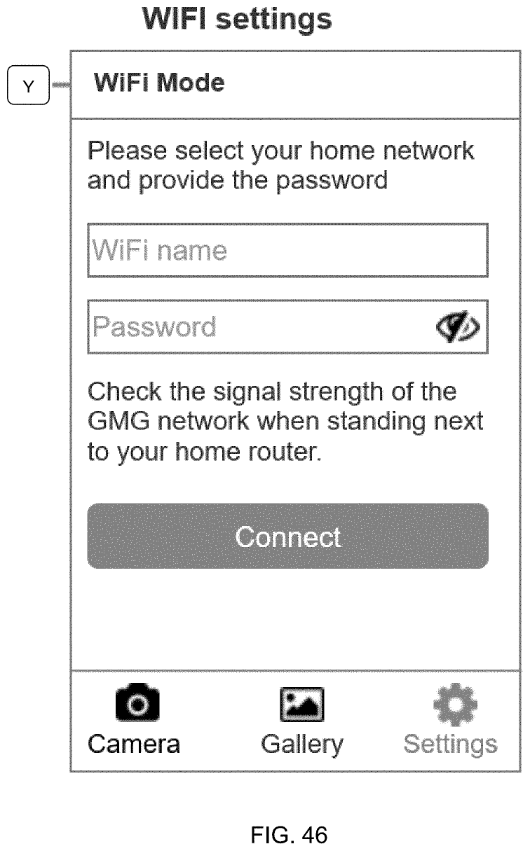

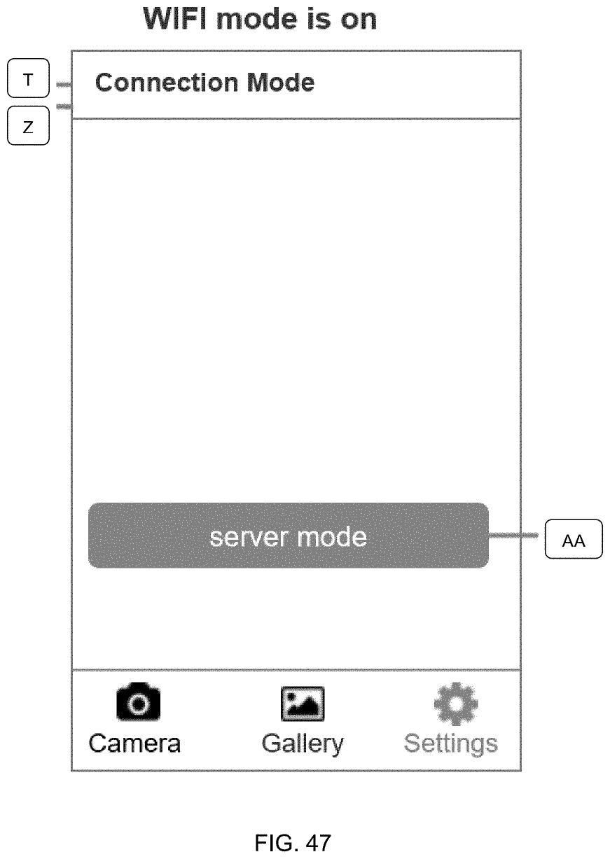

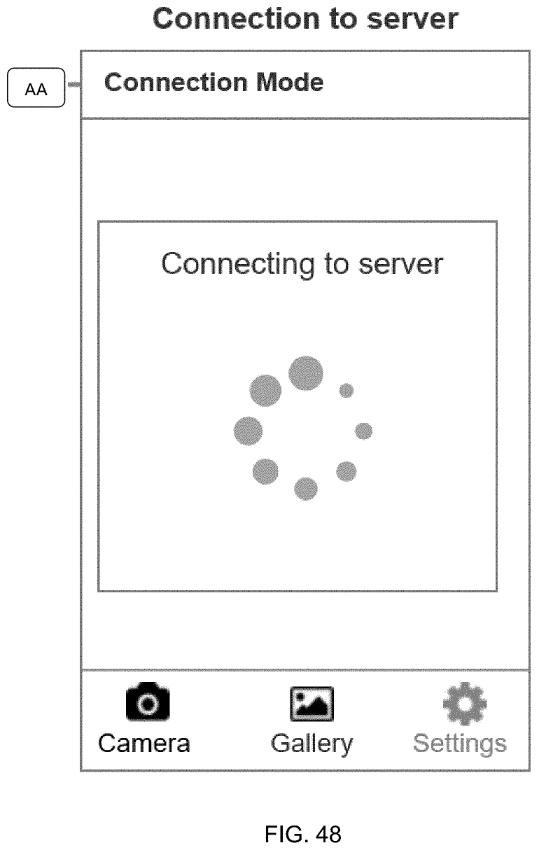

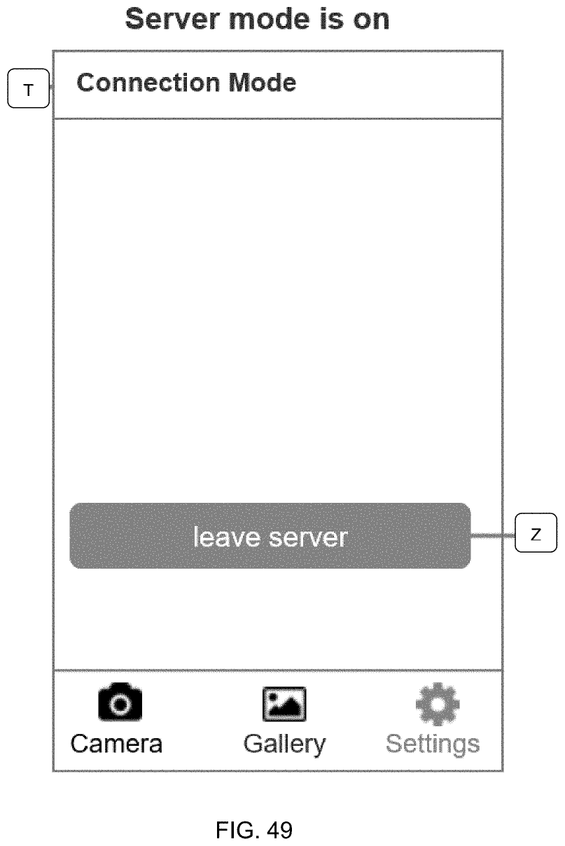

In some embodiments, an application may be stored on a server connected to the Internet and downloaded to the client device 1100. As non-limiting examples, the application may be stored in the Apple App Store or any other App store. The application may then be run on the client device 1100 to assist the user in controlling the camera mechanism 110. FIGS. 21-49 are example screens that may be displayed to the user on the client device 1100 so that the user may remotely control the camera mechanism 110.

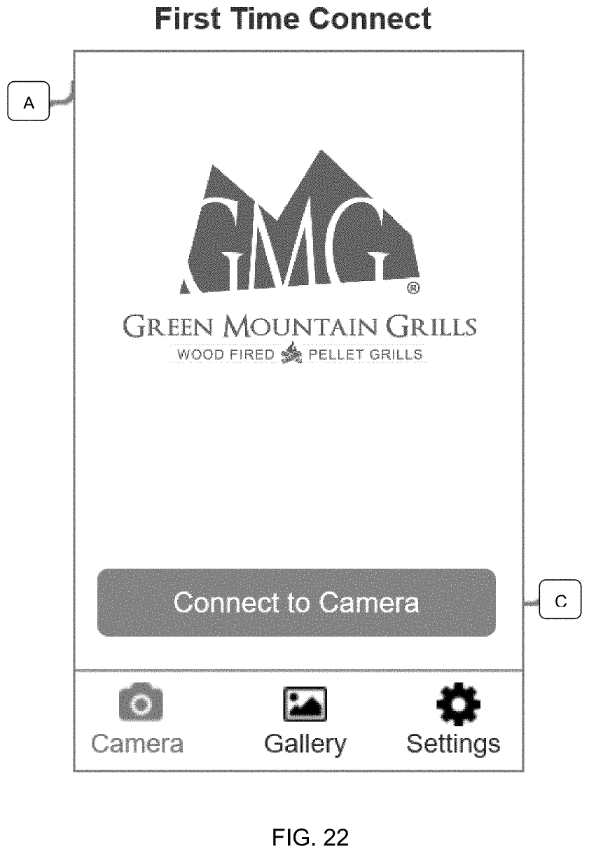

FIG. 21 is an example of a splash screen that may be displayed on the client device 1100 for use by the user. FIGS. 22-30 are example screens that may be displayed and used to assist the user in connecting the imaging device (camera) and the client device (cell phone or computer) of the user to a WiFi network.

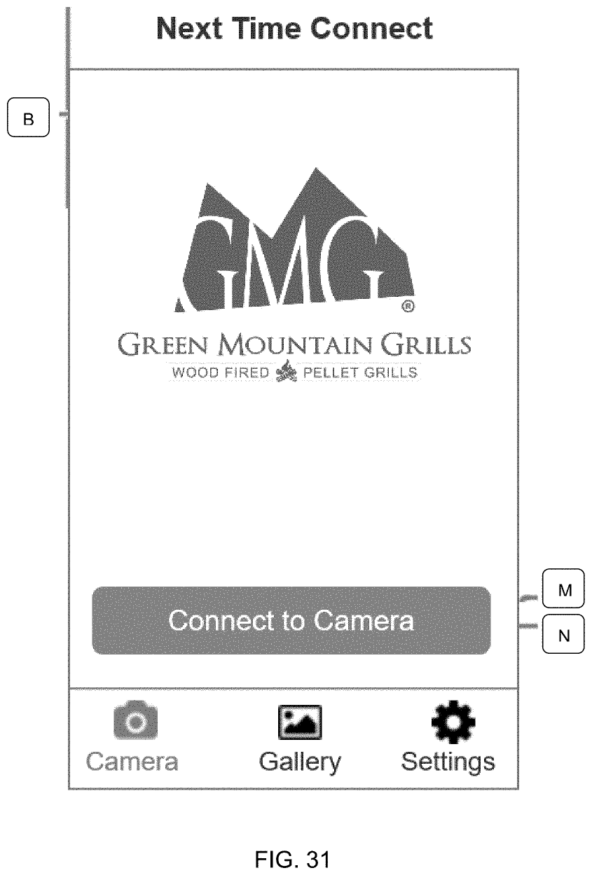

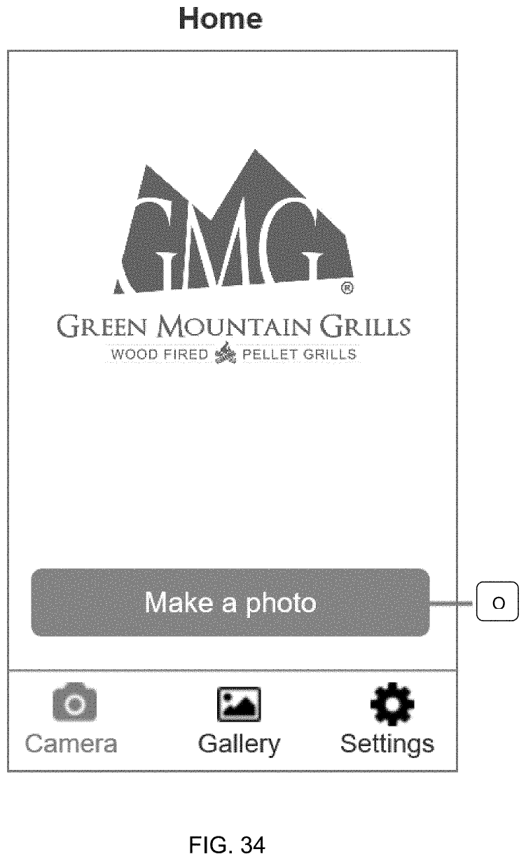

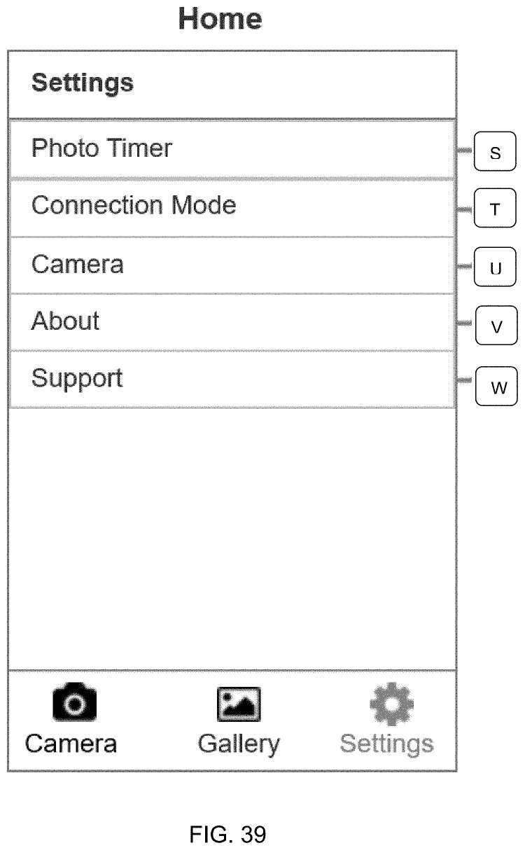

FIGS. 31-33 are example screens that may be used to assist the user after the WiFi connections for the imaging device and the client device have been established. FIGS. 34-38 are example screens that may be used to take and view one or more photographs and/or videos of the inside of the grill 100. FIGS. 39-42 are example screens that may be used to periodically take one or more photographs and/or videos of the inside of the grill 100.

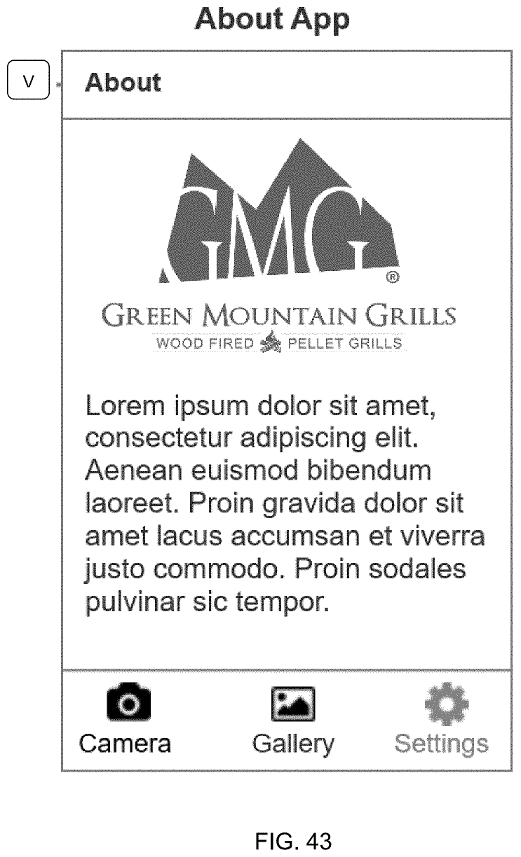

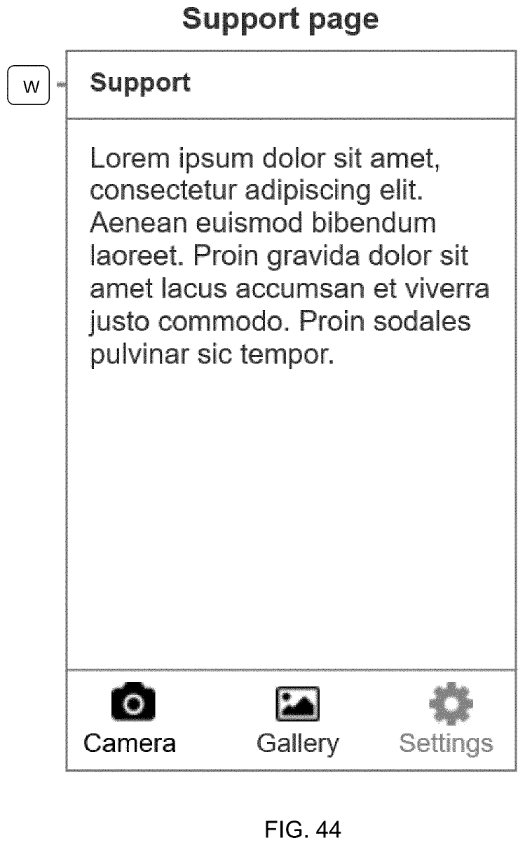

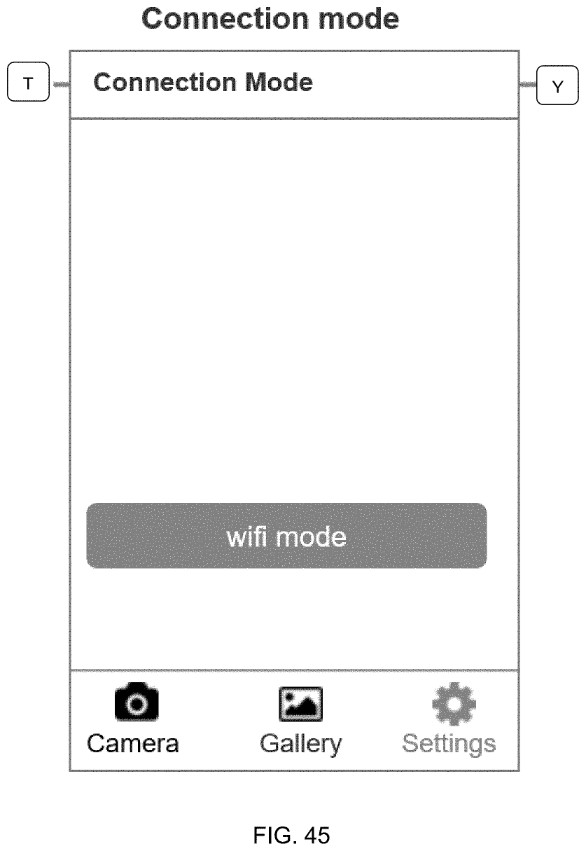

FIG. 43 is an example of an about application screen that may be used to inform the user about the use of the present invention. FIG. 44 is an example support page that may be used to inform the user about support matters, such as online resources that may be referenced on the Internet. FIGS. 45-49 are example screens that may be used by the user to connect to a server.

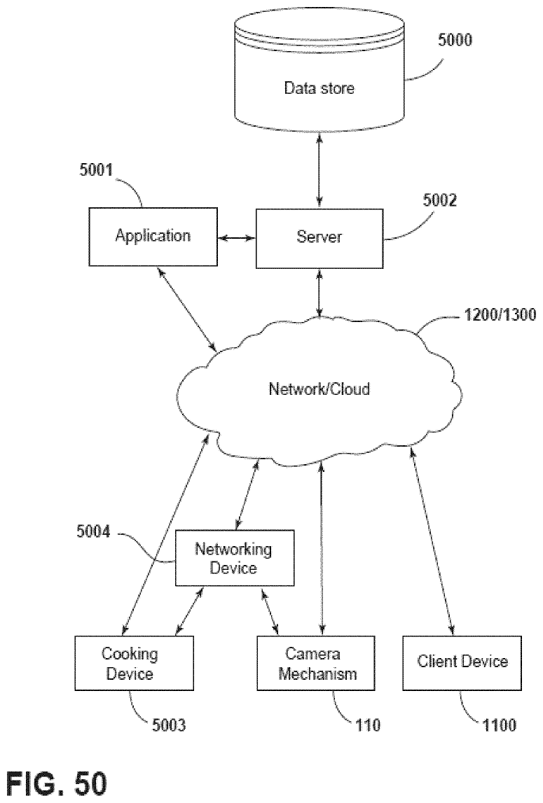

Referring to FIG. 50, in some examples, the cooking device 5003 and/or the camera mechanism 110 may be communicatively coupled with one or more remote sites such as a remote server 5002 via a network/cloud 1200/1300. The network/cloud 1200/1300 represents one or more systems by which the cooking device 5003 and/or the camera mechanism 110 may communicate with the remote server 5002. Accordingly, the network/cloud 1200/1300 may be one or more of various wired or wireless communication mechanisms, including any desired combination of wired and/or wireless communication mechanisms and any desired network topology (or topologies when multiple communication mechanisms are utilized). Exemplary communication networks 1200/1300 include wireless communication networks (e.g., using Bluetooth, IEEE 802.11, etc.), local area networks (LAN) and/or wide area networks (WAN), including the Internet and the Web, which may provide data communication services and/or cloud computing services. The Internet is generally a global data communications system. It is a hardware and software infrastructure that provides connectivity between computers. In contrast, the Web is generally one of the services communicated via the Internet. The Web is generally a collection of interconnected documents and other resources, linked by hyperlinks and URLs. In many technical illustrations when the precise location or interrelation of Internet resources are generally illustrated, extended networks such as the Internet are often depicted as a cloud (e.g. 1200/1300 in FIG. 50). The verbal image has been formalized in the newer concept of cloud computing. The National Institute of Standards and Technology (NIST) provides a definition of cloud computing as “a model for enabling convenient, on-demand network access to a shared pool of configurable computing resources (e.g., networks, servers, storage, applications, and services) that can be rapidly provisioned and released with minimal management effort or service provider interaction.” Although the Internet, the Web, and cloud computing are not exactly the same, these terms are generally used interchangeably herein, and they may be referred to collectively as the network/cloud 1200/1300.

The server 5002 may be one or more computer servers, each of which may include at least one processor and at least one memory, the memory storing instructions executable by the processor, including instructions for carrying out various steps and processes. The server 5002 may include or be communicatively coupled to a data store 5000 for storing collected data as well as instructions for operating the cooking device 5003, the camera mechanism 110, etc. that may be directed to and/or implemented by the cooking device 5003 and/or the camera mechanism 110 with or without intervention from a user and/or the client device 1100. Further, the server 5002 may store information related to multiple cooking devices 5003, food items, usage characteristics, errors, etc. and operate the cooking device 5003 and/or the camera mechanism in conjunction with the stored information with or without intervention from a user and/or the client device 1100.

With further reference to FIG. 50, the server 5002 also generally implements features that may enable the cooking device 5003 and/or the camera mechanism 110 to communicate with cloud-based applications 5001. Communications from the cooking device 5003 and/or the camera mechanism 110 can be directed through the network/cloud 1200/1300 to the server 5002 and/or cloud-based applications 5001 with or without a networking device 5004, such as a router and/or modem. Additionally, communications from the cloud-based applications 5001, even though these communications may indicate one of the cooking device 5003 and/or the camera mechanism 110 as an intended recipient, can also be directed to the server 5002. The cloud-based applications 5001 are generally any appropriate services or applications 5001 that are accessible through any part of the network/cloud 1200/1300 and may be capable of interacting with the cooking device 5003 and/or the camera mechanism 110.

In various examples, the client device 1100 can be feature-rich with respect to communication capabilities, i.e. have built in capabilities to access the network/cloud 1200/1300 and any of the cloud-based applications 5001 or can be loaded with, or programmed to have, such capabilities. The client device 1100 can also access any part of the network/cloud 1200/1300 through industry standard wired or wireless access points, cell phone cells, or network nodes. In some examples, users can register to use the remote server 5002 through the client device 1100, which may provide access to the cooking device 5003 and/or the camera mechanism 110 and/or thereby allow the server 5002 to communicate directly or indirectly with the cooking device 5003 and/or the camera mechanism 110. In various instances, the cooking device 5003 and/or the camera mechanism 110 may also communicate directly, or indirectly, with the client device 1100 or one of the cloud-based applications 5001 in addition to communicating with or through the server 5002. According to some examples, the cooking device 5003 and/or camera mechanism 110 can be preconfigured at the time of manufacture with a communication address (e.g. a URL, an IP address, etc.) for communicating with the server 5002 and may or may not have the ability to upgrade or change or add to the preconfigured communication address.

Referring still to FIG. 10, when a new cloud-based application 5001 is developed and introduced, the server 5002 can be upgraded to be able to receive communications for the new cloud-based application 5001 and to translate communications between the new protocol and the protocol used by the cooking device 5003 and/or the camera mechanism 110. The flexibility, scalability and upgradeability of current server technology renders the task of adding new cloud-based application protocols to the server 5002 relatively quick and easy.

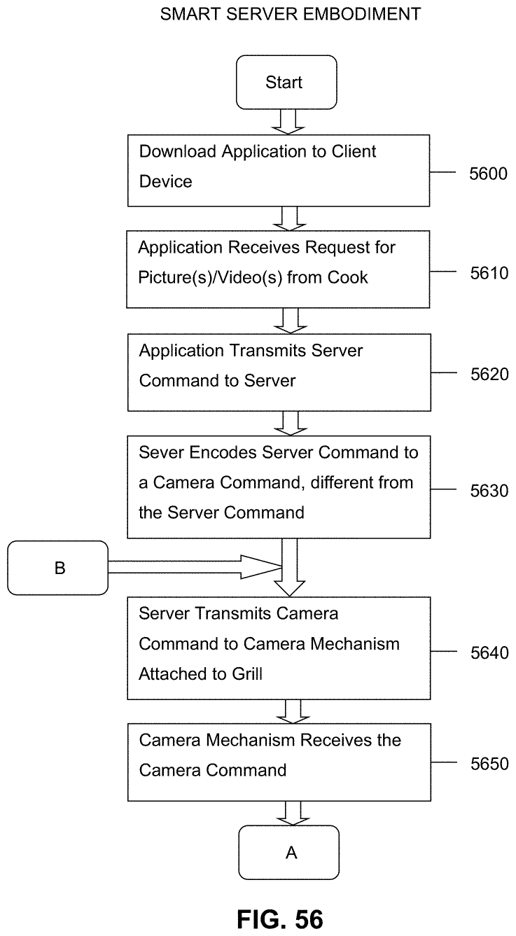

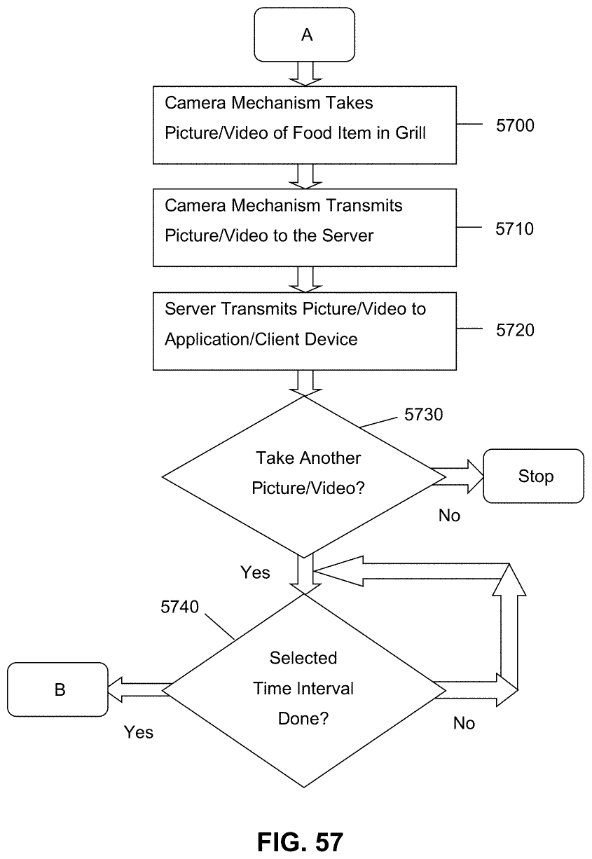

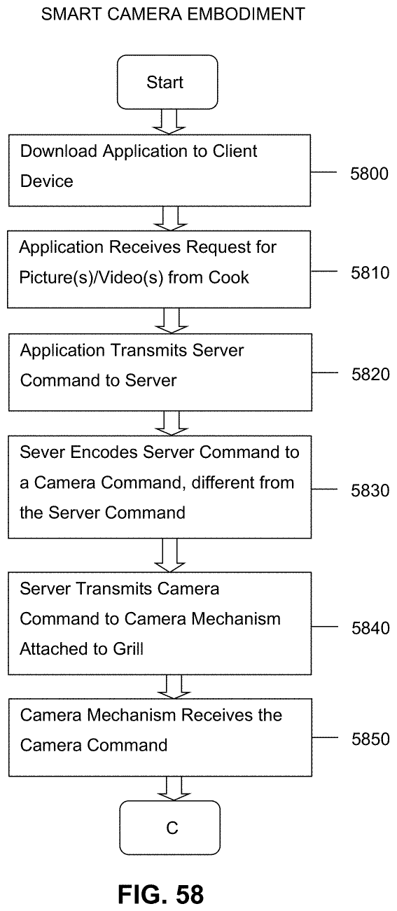

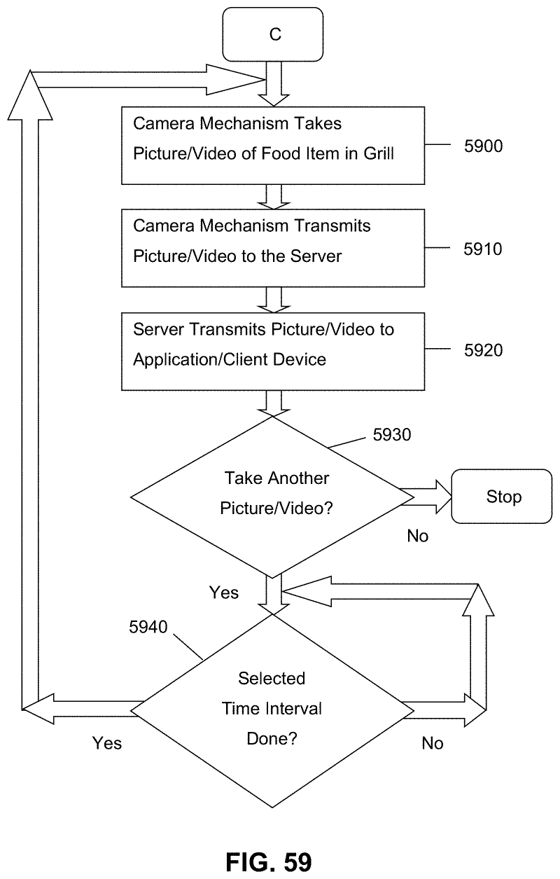

With reference to the flowcharts in FIGS. 56-59, in some embodiments an application program (or application) may be downloaded onto a client device 1100 (preferably a cell phone or tablet for their mobility although a desk top computer can also be used) so that the client device 1100 may run and operate the application. (Steps 5600, 5800) The application may originate and be downloaded from any desired source. As non-limiting examples, the application may be downloaded from a website running on a server 5300 on the Internet. As another option, the application may be downloaded from an application store via a cellular network, the Internet and/or any other desired communication network.

In another embodiment, the application may be stored and operated on a server 5300 on the Internet and the application may be run as a Software as a Service (SaaS). This allows the application to be easily updated on the server 5300, as opposed to having to update all the applications on a plurality of different client devices 1100 being operated by a corresponding plurality of cooks/users.

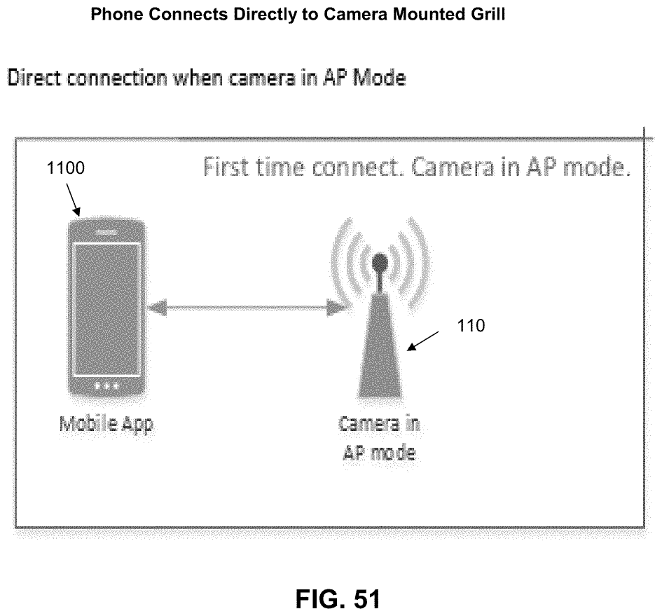

With reference to FIG. 51, the client device 1100 (labeled Mobile App) may be connected to the camera mechanism 110, comprising a wireless transceiver and computer logic, using any desired protocol. As a non-limiting example, the client device 1100 may be in communication with the camera mechanism 110 using Access Point mode (AP mode). To start the AP mode, the user may select an icon on the user device to start the application running. As a non-limiting example, the icon “Connect to Camera” C illustrated on interface A in FIG. 22 may be selected to start the process of the client device 1100 connecting to the camera mechanism 110. In some embodiments, the application will require the client device 1100 to be in close proximity to the camera mechanism 110 so that a successful pairing may be completed. In some embodiments the client device 1100 may scan a bar code on the camera mechanism 110 to pair the camera mechanism 110 and the client device 1100. In yet other embodiments, the client device 1100 may be connected to the camera mechanism 110 using the Bluetooth protocol.

While AP mode (or any other wireless mode) may be used for all communications between the client device 1100 and the camera mechanism 110, AP mode may be used during the first time the client device 1100 and the camera mechanism 110 are connected. AP mode may be particularly advantageous during a first time connect so that the client device 1100 (mobile app) and/or camera mechanism 110 may be initialized and configured to recognize and find each other. The short range proximity requirement for AP mode provides some security, as it ensures that only a client device 1100 that was physically close to the camera mechanism 110 may be used with the camera mechanism 110. In addition, the claimed invention may use transmission control protocol (TCP) as a protocol for transmitting information/data over the Internet.

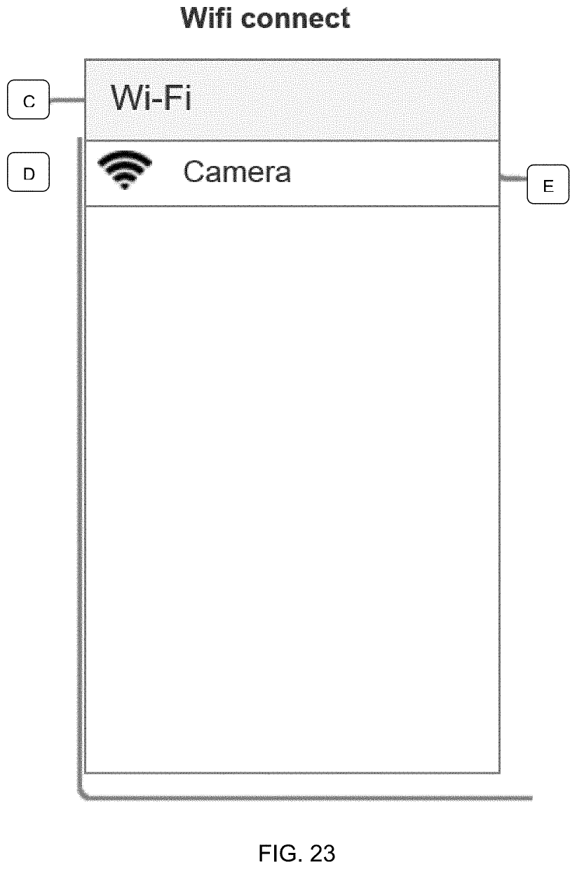

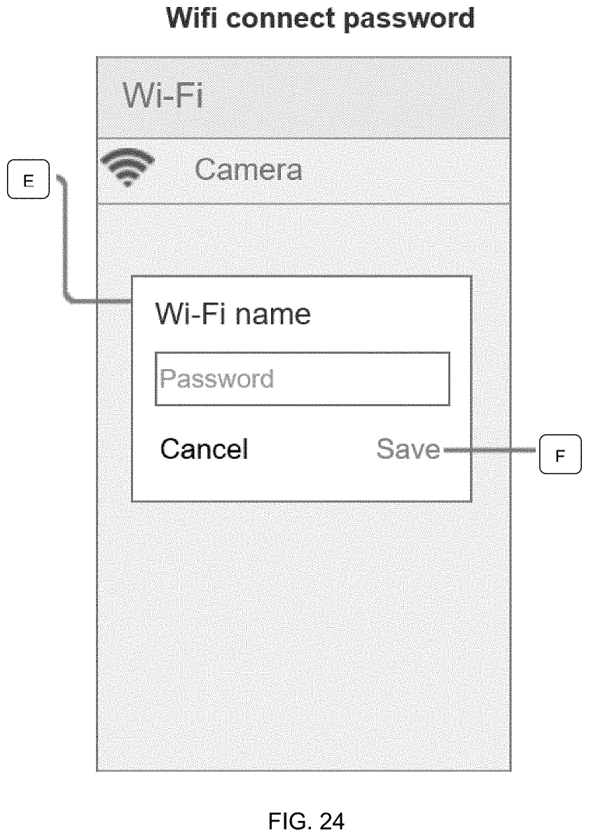

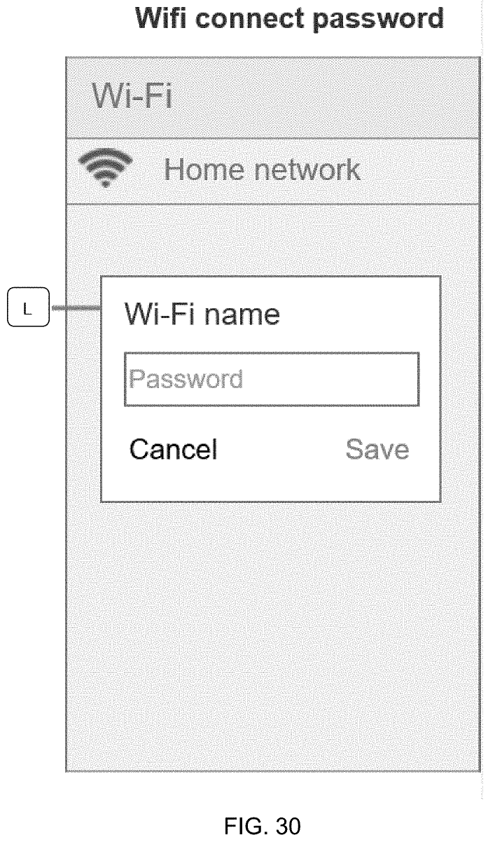

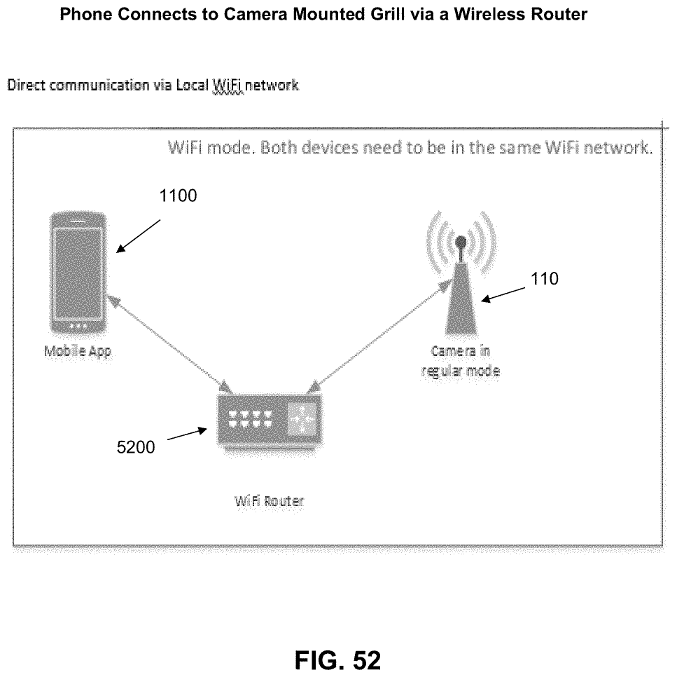

FIG. 52 illustrates that the client device 1100 may communicate with the camera mechanism 110 via a wireless router 5200 (a WiFi router, as a non-limiting example of a specific type of wireless router 5200, is illustrated). This communication method requires both the client device 1100 and the camera mechanism 110 to be on the same wireless router network. As a non-limiting example, the user may select the icon “Connect to Camera” C illustrated in interface A of the client device 1100 in FIG. 22. FIG. 23 illustrates an example interface that allows a user on a client device 1100 to select the icon “Camera” to connect to the camera mechanism 110 via a wireless router. FIG. 30 illustrates an example screen for allowing a user to enter a password to join a home network. An application running on the client device 1100 may assist a user in setting up a password, typically selected by the user, and then the camera mechanism 110 may verify the user in future connections by requesting the previously established password from the client device 1100. FIG. 24 illustrates an example interface that shows that a user may choose Camera from the list of local WiFi networks in the client device 1100 WiFi Settings, in order to connect to the camera in AP Mode. The WiFi connection is secured by a predefined password and the user that the user may need to provide to the connect to the network (to camera mechanism 110). In another embodiments, the application running on the client device 1100 may use the interface illustrated in FIG. 24 to allow a password to be entered and transmitted to the camera mechanism 110, either for setting up the password the first time or for receiving the password to authenticate the user operating the client device 1100 on subsequent connections.

Any type of routing protocol may be used for communications between the client device 1100 and a wireless router or for communications between a wireless router 5200 and the camera mechanism 110. As non-limiting examples, the routing protocol may be Routing Information Protocols (RIP), Interior Gateway Protocol (IGRP), Open Shortest Path First (OSPF), Exterior Gateway Protocol (EGP), Enhanced interior gateway routing protocol (EIGRP), Border Gateway Protocol (BGP) or Intermediate System-to-Intermediate System (IS-IS).

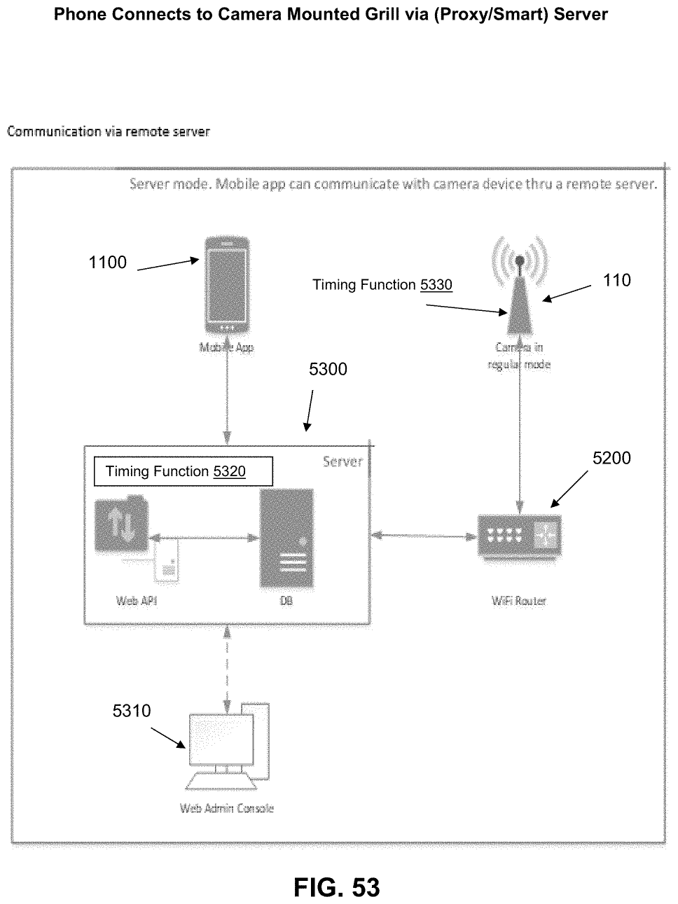

FIG. 53 illustrates a communication method where the client device 1100 and the camera mechanism 110 may communicate over vast geographical distances (worldwide). In this embodiment, the client device 1100, possibly via a wireless router, not shown, may communicate with a server 5300. This communication may be through a cellular network, the Internet and/or any other communication network. The server 5300, using a cellular network, the Internet and/or any other communication network may communicate with the camera mechanism 110, possible via a wireless router 5200. A web admin console 5300 may also be in communication with the server 5300. In this embodiment, the user may select to run the application on the client device 1100. As a non-limiting example, an initial opening screen A, as illustrated in FIG. 22, may be displayed on the client device 1100. The user may select an option, such as the icon “Connect to Camera” C illustrated on the opening screen A. The client device 1100 may then automatically connect to the camera mechanism 110 via, as non-limiting examples, one or more wireless routers, a cellular network and/or the Internet. In some embodiments, the camera mechanism 110 may request a user name and/or password to be entered into the client device 1100 to authenticate the user.

The application running on the client device 1100 may communicate with the server 5300 using, as a non-limiting example, an application programming interface (API). In some embodiments, the server 5300 may communicate with the camera mechanism 110 using an API. The APIs used in practicing the invention may follow the Representational State Transfer (REST) API architectural style and are preferably resource based. The REST architectural style preferably includes the constraints of a uniform interface, stateless, cacheable, client-server, layered system and, optionally, code on demand. In other embodiments, the API may follow the Simple Object Access Protocol (SOAP) API protocol. The APIs in the present invention may also be web APIs.

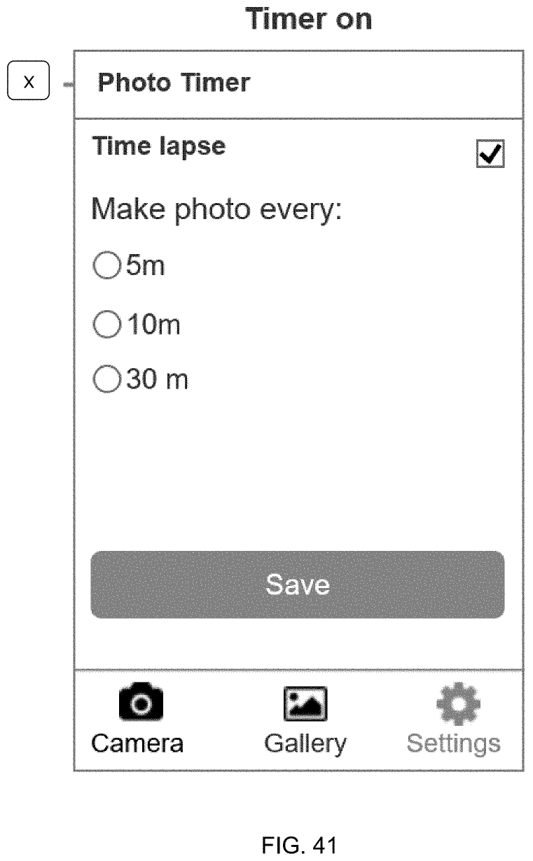

The client device 1100, preferably running the application, may receive a request from a cook for a plurality of pictures, separated by a selected time interval, of the food item(s) in the grill 100. (Steps 5610 and 5810) In preferred embodiments, the application may provide a menu list that allows the cook to select an option of receiving pictures at a selected time interval and also allows the cook to select a desired time interval between receiving photographs. As an example, FIG. 41 illustrates a possible screen that may be displayed as part of the application that allows the user to select a time interval between pictures taken and sent to the user in real-time. As non-limiting examples, the application may allow for pictures or videos of the food item in the grill 100 to be taken and transmitted to the client device 1100 of the cook once every 5 seconds, 10 seconds, 30 seconds, one minute, two minutes, five minutes, 10 minutes, 30 minutes or one hour, depending on the time interval selected by the cook. In another embodiment, the cook may enter the selected time interval in seconds, minutes or hours for receiving the pictures/videos using any desired icon or method currently known or developed in the future.

In a preferred embodiment, the cook may change the selected time interval between receiving pictures/videos at any time during the cooking process. Thus, the cook may start out only wanting pictures/videos once every minute, but may later change the selected time interval to once every 10 seconds once the food item is close to being done, i.e., fully cooked. In another embodiment, the camera mechanism 110 may automatically use a longer selected time interval and slowly reduce the time between pictures as the food items cook.

In another embodiment, the camera mechanism may detect the food item in the grill 100 and, based on the food item, determine a probable cooking time. The camera mechanism 1100 may take and send pictures in real-time less frequently (as an example, every two minutes) at the start of the cooking process, but take and send pictures in real-time more frequently (as an example, ever 15 seconds) near the expected completion of the cooking process. In some embodiments, the rate of pictures taken may be gradually adjusted during the cooking process.

In another embodiment, the camera mechanism 1100 may include computer logic that enables machine learning that allows the camera mechanism to determine how well done a food time is. In this manner the camera mechanism 1100 may be able to determine when the food item is getting closer to being done and automatically increase the rate (lower the time interval between pictures) of the pictures as food items near completion of the cooking process. In some embodiments, the camera mechanism 1100 may send an alert to the client device 110 to notify the user to remove the food items when the camera mechanism 1100, using machine learning, has determined the food items are fully cooked. In some embodiments, the grill 100 may be turned off or the temperature lowered (if these options are enable by the user) by the camera mechanism 1100 when the machine learning has determined the food items are fully cooked.

In another embodiment, the cook may cancel receiving the pictures/videos on the client device 1100 of the cook at any time after starting the process of receiving the plurality of pictures/videos of the food items in the grill 100.

The client device 1100 may transmit a server 5300 command for periodic pictures of the food item in the grill 100 to a server 5300, possibly via a wireless router 5200. (Steps 5620 and 5820). It should be appreciated that the client device 1100 could send, using the same method, any number or type of different commands to the server 5300. As non-limiting examples, the client device 1100 could transmit a request requesting the return of the current temperature inside the grill 100, a command to set the current temperature, a command to turn off the grill 100 or a request for a single picture or running video of the food item(s) in the grill 100.

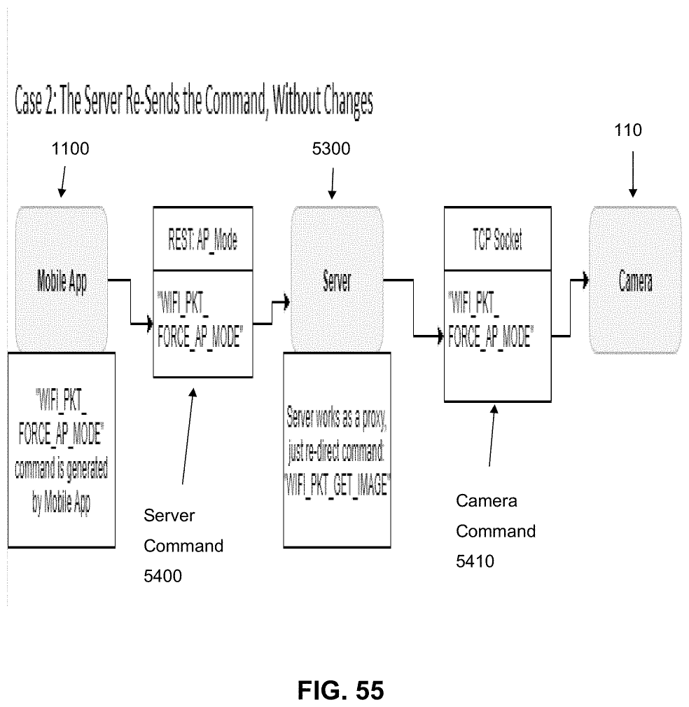

With reference to FIG. 55, the server 5300 may act as a proxy and simply relay the received server command 5400, unchanged, as a camera command 5410 to the camera mechanism 110. The specific non-limiting example in FIG. 55 is for the client device 1100 (Mobile App) to transmit the server command 5400 “WIFI_PKT_FORCE_AP_MODE” to the server 5300 and then for the server 5300 to transmit the camera command 5410 (unchanged from the server command 5400) “WIFI_PKT_FORCE_AP_MODE” to the camera mechanism 110.

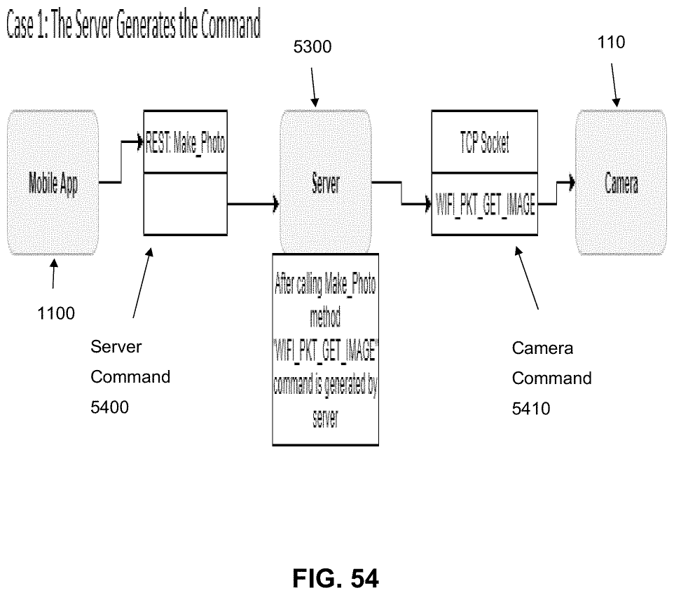

With reference to FIG. 54, the server 5300 may act as a smart server 5300 and encode the server command 5400, in a first format, into a camera command 5410, in a second format, wherein the first format is different from the second format. It should be appreciated that the server command 5400 and camera command 5410 are not limited in any way to any specific type of format. The application running on the client device 1100 may transmit any desired code representing any desired action and the camera mechanism 5410 may receive any desired code representing any desired action. In some embodiments, the application running on the client device 1100 may “speak” the same language, i.e., use the same format or the same code, as the camera mechanism 110. In this case, the server commands 5400 may be transmitted by the server 5300 directly to the camera mechanism 110 unchanged as the camera commends 5410.

In other embodiments, the application running on the client device 1100 might “speak” a different language than the camera mechanism 110. As one possible solution to this problem, the server 5300 may identify the type of cooking device 5003/grill 100/camera mechanism 110 (hereafter camera mechanism 110). This may be performed by the server 5300 sending a request to the camera mechanism 110 to return an identification of the camera mechanism 110. The camera mechanism 110 may transmit the identification to the server 5300. The server 5300 may identify an appropriate electronic look-up table for the cooking device 5003, grill 100 or camera mechanism 110 based on the received identification. The server 5300 may then look-up the server command 5400 in the electronic look-up table to determine an associated camera command 5410. The server 5300 may then, after receiving the server command 5400 from the application running on the client device 1100 transmit the camera command 5410 to the camera mechanism 110.

The specific non-limiting example in FIG. 54 is for the client device 1100 (Mobile App) to transmit the server command 5400 “Make_Photo” to the server 5300 and then for the server 5300 to encode the server command 5400 into a camera command 5410 “WIFI_PKT_GET_IMAGE.” The server 5300 may then transmit the camera command 5410 (encoded from the server command 5400) to the camera mechanism 110.

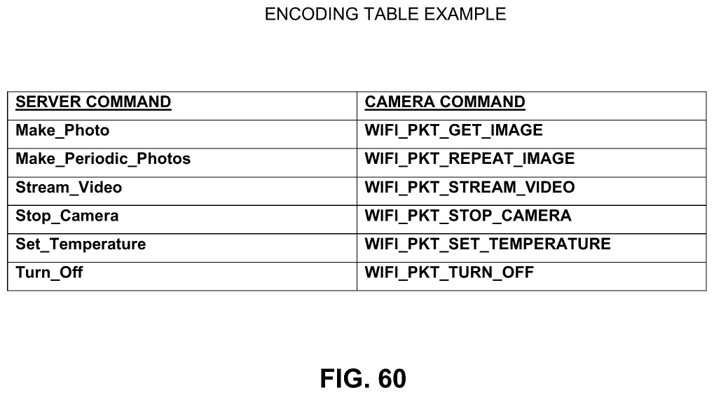

The server 5300 may encode the server command 5400 into a camera command 5410 using any desired method. (Step 5630 and 5830) As a non-limiting example, FIG. 60 illustrates a very simple encoding electronic look-up table that may be used by the server 5300 to encode a server command 5400 into a camera command 5410. The received server command 5400 may be matched to a server command 5400 in the first column of the encoding electronic look-up table and the associated camera command 5410 is determined to be the camera command 5410 in the same row as the matched server command 5400. This allows the client device 1100 to transmit a server command 5400 to the server 5300 and for the camera mechanism 110 to receive an associated camera command 5410 from the server 5300.

One of the illustrated examples is for the server command 5400 “Make_Photo” to be encoded into the camera command 5410 “WIFI_PKT_GET_IMAGE.” As a non-limiting example, this camera command 5410 could be used to instruct the camera mechanism 110 to take a picture and transmit the picture to the server 5300 in real-time.

The camera mechanism 110 may include any type of memory, such as, as a non-limiting example, a type of Read Only Memory (ROM), that stores a plurality of different routines that may be performed by the camera mechanism 110. Each of the stored routines may be associated with a particular camera command 5410, such that upon the camera mechanism 110 receiving the camera command 5400, the camera mechanism launches the performance of a corresponding stored routine for that camera command 5400.

Thus, upon the camera mechanism 110 receiving a camera command 5410, the camera mechanism 110 may initiate, i.e., launch or run, one of the stored routines in the memory on the camera mechanism 110. As a specific example, once the camera mechanism 110 receives a camera command 5410 to take and transmit a picture in real-time, the control unit 600, comprising computer logic, may perform a stored routine that will take and transmit the picture in real-time to the client device 1100. The saved routine may comprise any number of desired steps that will be performed possibly based upon receiving a single camera command 5410.

As a non-limiting example, after receiving a camera command 5410 to take and transmit a picture, a routine stored in memory of the camera mechanism 110 may start by performing a safety check to make sure the camera 210 will not be damaged by inserting the camera 210 into the cooking chamber 120. The safety check may include verifying the camera 210 has not exceeded a maximum duty cycle, for the temperature within the cooking chamber 120, or a thermometer on the camera 210 or the camera lens 150 may be read to make sure the camera 210 or camera lens 150 are not hotter than their allowed maximum temperature. If the safety check is not passed, an error message may be communicated to the client device 1100 to let the user know that an error condition has been reached, preferably notifying the user of the nature of the problem.

Upon passing the safety check, the control unit 600 may then engage the electric motor 340 to extend the camera lens 150 through an aperture 130 in the grill 100 from a first position outside the cooking chamber 120 to a second position inside the cooking chamber 120. Once the camera lens 150 is inside of the cooking chamber 120, the food item will be within the line of sight of the camera lens 150. Upon the camera lens 150 reaching the second position inside the grill, the camera 210 may take one or more pictures separated by a desired time interval. The camera mechanism 110, in real-time, preferably transmits each picture immediately after the picture is taken, to the server 5300 so the server 5300 in turn may immediately transmit the picture to the application running on the client device 1100. This allows the user to see the food item in the grill 100 in real-time as the food item is being cooked or as close to real-time as electronic communications allow.

The picture may be transmitted using any desired protocol, such as, as a non-limiting example, in Picture Transfer Protocol (PTP) and the picture may be in any desired format, such as, as non-limiting examples, Joint Photographic Experts Group (JPEG), High Definition (HD) or Graphics Interchange Format (GIF). After the desired pictures are taken and transmitted back to the client device 1100, or upon determining the time interval between pictures (such as, as a non-limiting example 60 seconds) is greater than a predetermined time period (such as, as a non-limiting example 30 seconds), the control unit 600 may engage the electric motor 340 to retract the camera lens 150 through the aperture 130 in the grill 100 from the second position inside the cooking chamber 120 to the first position outside the cooking chamber 120.

The process of extending the camera lens 150 into the cooking chamber 120, taking a picture and then retracting the camera lens 150 out of the cooking chamber 120 may be repeated any number of desired times to allow the user to receive any number of pictures separated by any desired time intervals. After receiving the picture, the server 5300 may transmit the picture to the client device 1100 for view by the cook on the client device 1100.

Another of the illustrated examples is for the server command 5400 “Make_Periodic_Photos” to be encoded into the camera command 5410 “WIFI_PKT_REPEAT_IMAGE.” In a preferred embodiment, an electronic look-up table may be used to encode the server command 5400 “Make_Periodic_Photos” into the camera command 5410 “WIFI_PKT_REPEAT_IMAGE.” The server 5300 may transmit this camera command 5410 to the camera mechanism 110 (Step 5640) and the camera mechanism 110 may receive the camera command 5410. (Step 5650) The camera mechanism 110 may take a picture of a food item in the grill 100 based on the camera command 5410. (Step 5700) The camera mechanism 110 may transmit the photograph to the server 5300. (Step 5710). The server 5300 may transmit the photograph to the client device 1100. (Step 5720). The camera mechanism 110 may stop the process if the camera mechanism 110 receives a stop command or reaches any desired termination condition. (Step 5730)

The camera mechanism 110 may, using a built in timing function, wait for the selected timer interval to pass before starting the process of taking another photograph. (Step 5740) The timing function may be and use any desired method of measuring time, such as, as non-limiting examples, a system clock which may be repeatedly read to monitor how much time has passed or the timing function may be an electronic timer that may be set with a desired time interval that may send an interrupt/alert when the desired time interval has passed. In this manner, the camera mechanism 110 may take pictures using any desired time interval. The time intervals between pictures may be selected by the user or the camera mechanism 110 may use a default time interval (which may change during the cooking of the food item) that is automatically determined to be the most appropriate.

The camera command 5410 may be used to instruct the camera mechanism 110 to take a series of photographs, separated by a selected time interval (which data could be received from the client data and also be sent to the camera mechanism 110), and to transmit the photographs, one at a time, to the server 5300. The server 5300 may transmit each of the photographs as they are received from the camera mechanism 110 to the client device 1100. This command requires the camera mechanism 110 to comprise a timing function and to take a series of photographs spaced apart by the selected time interval based on receiving a single camera command 5410 from the server 5300.

In another embodiment, a number of pictures may be cached in the server 5300. The number of pictures used may be selected by any desired means. As a non-limiting example, the user may be allowed to select a desired number of pictures to use to create a fast motion video. In another embodiment, the user is allowed to select how long the fast motion video should be. In this case the server may calculate the number of pictures required, once the time intervals between pictures are removed, to create the fast motion video of the selected time period.

The cached pictures may be combined by placing one after the other and replacing the actual time intervals between the pictures with another time interval, such as, as non-limiting examples, 1/30, 1/60 or 1/120 of a second. The pictures when combined without the actual separating time intervals may be used to create a fast motion video. The fast motion video may be transmitted to the client device 1100 so that the user may see the fast motion video of the food items cooking in the grill 100.

In an alternative embodiment, the server 5300 may recognize the server command 5400 “Make_Periodic_Photos” and the server 5300 may run a program that sends a plurality of “WIFI_PKT_GET_IMAGE” camera commands 5410 to the camera mechanism 110 at a selected time interval (Step 5840) and the camera mechanism 110 may receive each of the transmitted camera command 5410 (Step 5850). The camera mechanism 110, after receiving each “WIFI_PKT_GET_IMAGE” camera command 5410, temporally separated by the selected time interval, may take a photograph (Step 5900) of the food item in the grill 100.

In some embodiments, a safety check may periodically be performed while the camera lens 150 is inside the cooking chamber 120 or prior to inserting the camera lens 150 into the cooking chamber 120. In the event that the camera lens 150 has exceeded its allowed time within the cooking chamber 120 based on the temperature within the cooking chamber 120, the camera lens 150 may be removed from the cooking chamber 120 to prevent damage to the camera lens 150 even if the user had requested pictures to be taken during that time period. In other embodiments, the system may rate-limit how frequently pictures are taken to avoid damaging the camera lens 150 even if the user had requested pictures to be taken at a faster rate. The camera mechanism 110 or the server 5300 may keep track in a memory in the camera mechanism 110 or the server 5300 when and how long the camera lens 150 was within the cooking chamber 120 and the temperature inside the cooking chamber 120 while the camera mechanism 110 was inside. The camera mechanism 110 or the server 5300 may use this information, and possibly with other information, such as the temperature outside the grill 100 and/or the thermal limits of the camera lens 150, to determine whether or not it is safe to insert the camera lens 150 into the cooking chamber 120. If it is not safe, the camera lens 150 is not inserted into the cooking chamber 120, regardless of commands to take pictures.

The camera mechanism 110 may transmit the photograph back to the server 5300 (Step 5910), where the server 5300 may then transmit the photograph to the client device 1100 for review by the cook (Step 5920). The server 5300 may stop the process if the server 5300 receives a stop command from the client device 1100 or reaches any desired termination condition. (Step 5930) The server 5300 may, using a built in timing function, wait for the selected timer interval to pass before starting the process of taking another photograph. (Step 5940) This process requires the server 5300 to comprise a timing function and to send a plurality of camera commands 5410 to the camera mechanism 110 based on the server 5300 receiving a single server command 5400 from the client device 1100.

Another of the illustrated examples is for the server command 5400 “Stream_Video” to be encoded into the camera command 5410 “WIFI_PKT_STREAM_VIDEO.” As a non-limiting example, this camera command 5410 may be used to instruct the camera mechanism 110 to transmit/stream video to the server 5300 and the server 5300 could transmit/stream the video, in real-time, to the client device 1100. This would allow the client device 1100 to receive streaming video from the camera mechanism 110. In preferred embodiments, a safety check is continually performed for the camera lens 150 to verify that the camera lens 150 is not damaged due to excessive heat. If the camera lens 150 reaches or exceeds a safety thermal threshold for the camera lens 150, the camera lens 150 is extracted from the cooking chamber 120, thereby terminating any current video streaming. In preferred embodiments, a message is communicated from the camera mechanism 110 to the client device 1100 to inform the user that the camera lens 150 was withdrawn from the cooking chamber 120 to prevent damage to the camera lens 150.

Another of the illustrated examples is for the server command 5400 “Stop_Camera” to be encoded into the camera command 5410 “WIFI_PKT_STOP_CAMERA.” As a non-limiting example, this camera command 5410 may be used to instruct the camera mechanism 110 to stop taking and transmitting pictures and/or videos.

Another of the illustrated examples is for the server command 5400 “Set_Temperature” to be encoded into the camera command 5410 “WIFI_PKT_SET_TEMPERATURE.” As a non-limiting example, this camera command 5410, along with additional data representing a temperature received from the client device 1100, may be used to instruct the camera mechanism 110 to set a desired temperature of the cooking chamber in the grill 100.

Another of the illustrated examples is for the server command 5400 “Turn_Off” to be encoded into the camera command 5410 “WIFI_PKT_TURN_OFF.” As a non-limiting example, this camera command 5410 may be used to instruct the camera mechanism 110 to turn the grill 100 off.

It should be appreciated that while specific example server commands 5400 and specific example camera commands 5410 are used to illustrate the claimed invention, the server commands 5400 and the camera commands 5410 are not limited to these specific illustrated text strings and could easily be changed without departing from the claimed invention. Further, not all of these server commands 5400 and camera commands 5410 are needed and one or more may be removed and/or one or more server commands 5400 and camera commands 5410 may be added to the encoding electronic look-up table as desired. Thus, any desired number of server commands 5400 and corresponding camera commands 5410 may be used to perform any type or number of functions related to the camera mechanism 110 or the grill 100.

Other embodiments and uses of the above inventions will be apparent to those having ordinary skill in the art upon consideration of the specification and practice of the invention disclosed herein. It should be understood that features listed and described in one embodiment may be used in other embodiments unless specifically stated otherwise. The specification and examples given should be considered exemplary only, and it is contemplated that the appended claims will cover any other such embodiments or modifications as fall within the true scope of the invention.

The invention claimed is:

1. A cooking device that transmits a plurality of pictures or a video of a food item cooking in a cooking chamber of the cooking device to a client device, comprising:
a cooking chamber, with an aperture, configured to cook the food item;
a camera mechanism, mounted on the cooking chamber, in close proximity to the aperture, comprising:
a camera with a camera lens, wherein the camera is configured to take the plurality of pictures or the video of the food item cooking in the cooking chamber,
an electric motor that:
i) when engaged in a forward direction moves the camera lens through the aperture to a first position that allows the camera lens a field of view that includes the food item and
ii) when engaged in a reverse direction moves the camera lens through the aperture to a second position outside of the cooking chamber, and
a control unit, comprising:
a wireless transceiver configured to:
i) receive a camera command from the client device and electronically communicate the camera command to a computer logic, and
ii) electronically receive data from the camera and/or the computer logic and transmit the data to the client device, and
the computer logic configured to:
i) receive the camera command from the wireless transceiver,
ii) upon determining the camera command is a request for the plurality of pictures or the video, control the electronic motor and the camera to take the plurality of pictures or the video of the food item, and
iii) communicate the plurality of pictures or the video of the food item to the wireless transceiver so the wireless transceiver can communicate the plurality of pictures or the video of the food item to the client device.

2. The cooking device of claim 1, wherein the control unit further comprises a timing device, so that each picture in the plurality of pictures is taken and transmitted to the client device one at a time and separated by a selected timer interval.

3. The cooking device of claim 1, further comprising:
an aperture cover mounted on the grill near the aperture, wherein the aperture cover is configured to swing from a closed position that covers most or all of the aperture and an open position configured to allow an insertion of the camera lens into the cooking chamber.

4. The cooking device of claim 1, wherein the computer logic includes a safety check that prevents the camera mechanism from being damaged by excessive time inside of the cooking chamber.

5. A method for monitoring on a client device a cooking of a food item in a grill, comprising the steps of:
receiving by an application running on the client device a request for periodic pictures, at a selected time interval, of the food item in the grill;
transmitting, by the application, a server command, in a first format, for periodic pictures of the food item in the grill, to a server;
encoding, by the server, the server command, in the first format, for periodic pictures of the food item in the grill, into a camera command, wherein the camera command is in a second format different from the first format, the server comprises a timing function and the server is configured, based on receiving the server command, to transmit a plurality of camera commands, one at a time, at the selected time interval, to a control unit of a camera mechanism mounted on the grill; and
repeating a plurality of times, at the selected time interval, the steps of:
transmitting, by the server, the camera command to the control unit of the camera mechanism mounted on the grill,
receiving by the control unit, comprising a wireless transceiver and computer logic, the camera command from the server,
engaging, based on the camera command, an electrical motor in a forward direction that causes a movement of a camera lens of a camera from an outside position through an aperture in a cooking chamber of the grill to an inside position;
moving an aperture cover from a closed position covering the aperture to an open position not covering the aperture caused by the movement of the camera lens;
taking a picture of the food item in the cooking chamber using the camera lens,
transmitting by the control unit the picture of the food item to the server,
engaging the electrical motor in a reverse direction after taking the picture that causes a movement of the camera lens of the camera from the inside position through the aperture in the cooking chamber to the outside position outside of the cooking chamber;
moving the aperture cover from the open position not covering the aperture to the closed position covering the aperture caused by gravity and the movement of the camera lens, and
transmitting, by the server, the picture to the application running on the client device for visual inspection.

6. The method of claim 5, wherein the encoding, by the server, the server command, comprises the steps of:
finding the server command in an electronic look-up table; and
locating the camera command in the electronic look-up table that is associated with the server command.

7. The method of claim 5, wherein the application running on the client device communicates with the server using an application programming interface (API).

8. The method of claim 7, wherein the API follows the REST API architectural style.

9. The method of claim 7, wherein the API follows the SOAP API protocol.

10. The method of claim 5, wherein a wireless router is used for routing transmissions between the application running on the client device and the server.

11. The method of claim 5, wherein a wireless router is used for routing transmissions between the server and the control unit of the camera mechanism mounted on the grill.

12. A method for monitoring on a client device a cooking of a food item in a grill, comprising the steps of:
receiving by an application running on the client device a request for periodic pictures, at a selected time interval, of the food item in the grill;
transmitting, by the application, a server command, in a first format, for periodic pictures of the food item in the grill, to a server;
encoding, by the server, the server command, in the first format, for periodic pictures of the food item in the grill, into a camera command, wherein the camera command is in a second format different from the first format;
transmitting, by the server, the camera command to a control unit of a camera mechanism mounted on the grill;
receiving by the control unit, comprising a wireless transceiver and computer logic, the camera command from the server, wherein the control unit comprises a timing function and is configured, based on receiving the server command, to transmit a plurality of pictures, one at a time, at the selected time interval, to the server; and
repeating a plurality of times, at the selected time interval, the steps of:
engaging, based on the camera command, an electrical motor in a forward direction that causes a movement of a camera lens of a camera from an outside position through an aperture in a cooking chamber of the grill to an inside position;
moving an aperture cover from a closed position covering the aperture to an open position not covering the aperture caused by the movement of the camera lens;
taking a picture of the food item in the cooking chamber using the camera lens,
transmitting by the control unit the picture of the food item to the server,
engaging the electrical motor in a reverse direction after taking the picture that causes a movement of the camera lens of the camera from the inside position through the aperture in the cooking chamber to the outside position outside of the cooking chamber, and
moving the aperture cover from the open position not covering the aperture to the close position covering the aperture caused by gravity and the movement of the camera lens, and
transmitting, by the server, the picture to the application running on the client device for visual inspection.

13. The method of claim 12, wherein the encoding, by the server, the server command, comprises the steps of:
finding the server command in an electronic look-up table; and
locating the camera command in the electronic look-up table that is associated with the server command.

14. The method of claim 12, wherein the application running on the client device communicates with the server using an application programming interface (API).

15. The method of claim 14, wherein the API follows the REST API architectural style.

16. The method of claim 14, wherein the API follows the SOAP API protocol.

17. The method of claim 12, wherein a wireless router is used for routing transmissions between the application running on the client device and the server.

18. The method of claim 12, wherein a wireless router is used for routing transmissions between the server and the control unit of the camera mechanism mounted on the grill.

19. A method for monitoring on a client device a cooking of a food item in a grill, comprising the steps of:
transmitting, by a client device, a server command, in a first format, for a picture of the food item in the grill, to a server;
encoding, by the server, the server command, in the first format, for the picture of the food item in the grill, into a camera command, wherein the camera command is in a second format different from the first format;
transmitting, by the server, the camera command to a control unit of a camera mechanism mounted on the grill;
receiving by the control unit, comprising a wireless transceiver and computer logic, the camera command from the server;
taking a picture of the food item in the cooking chamber using a camera lens of the camera mechanism mounted on the grill;
transmitting by the control unit the picture of the food item to the server; and
transmitting, by the server, the picture to the client device for visual inspection.

20. The method of claim 19, wherein the encoding, by the server, the server command, comprises the steps of:
finding the server command in an electronic look-up table; and
locating the camera command in the electronic look-up table that is associated with the server command.

21. The method of claim 19, wherein an application running on the client device communicates with the server using an application programming interface (API).

22. The method of claim 21, wherein the API follows the REST API architectural style.

23. The method of claim 21, wherein the API follows the SOAP API protocol.

24. The method of claim 19, wherein a wireless router is used for routing transmissions between the server and the control unit of the camera mechanism mounted on the grill.
